(19) United States
(12) Patent Application Publication
(10) Pub. No.: US 2023/0059644 A1
(43) Pub. Date: Feb. 23, 2023

(54) UPLINK POWER CONTROL PARAMETER INDICATION FOR MULTI-PANEL TRANSMISSION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Wooseok NAM, San Diego, CA (US); Tao LUO, San Diego, CA (US); Xiaoxia ZHANG, San Diego, CA (US)

(21) Appl. No.: 17/904,751

(22) PCT Filed: Apr. 21, 2020
(86) PCT No.: PCT/CN2020/085962

§ 371 Date: Aug. 22, 2022

(51) Int. Cl. H04W 52/14; H04W 52/42; H04W 52/54

(52) U.S. Cl. CPC H04W 52/146; H04W 52/42; H04W 52/54; H04B 7/0404

(57) ABSTRACT

Methods, systems, and devices for wireless communications are described. A user equipment (UE) may receive a control message associated with an uplink transmission from one or more antenna panels. In some cases, the control message may include a first indication associated with an uplink transmission configuration indicator and a second indication of an uplink power control parameter set identifier associated with the first indication. In some cases, the control message may include a bit, where a value of the bit indicates whether an uplink transmission configuration indicator is included in the control message or an uplink power control parameter set identifier is included in the control message. The UE may then communicate with the base station based on receiving the control message.

### CROSS REFERENCE

The present Application is a 371 national stage filing of International PCT Application No. PCT/CN2020/085962 by YUAN et al. entitled “UPLINK POWER CONTROL PARAMETER INDICATION FOR MULTI-PANEL TRANSMISSION,” filed Apr. 21, 2020, which is assigned to the assignee hereof, and which is expressly incorporated by reference in its entirety herein.

### FIELD OF TECHNOLOGY

The following relates generally to wireless communications and more specifically to uplink power control parameter indication for multi-panel transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Current techniques to indicate uplink power control parameter may be deficient.

### SUMMARY

The described techniques relate to improved methods, systems, devices, and apparatuses that support uplink power control parameter indication for multi-panel transmission. Generally, the described techniques provide for updating an uplink transmission configuration indicator and uplink power control parameter for one or more physical downlink control channels scheduling physical uplink shared channel from multiple transmission and/or reception points. In some cases, a control message may provide for jointly updating the uplink transmission configuration indicator and the uplink power control parameter. In some cases, a control message may provide for separately updating the uplink transmission configuration indicator and the uplink power control parameter. Additionally or alternatively, the described techniques provide for updating (jointly or separately) an uplink transmission configuration indicator and uplink power control parameter for a physical uplink control channel.

### BRIEF DESCRIPTION OF THE DRAWINGS

FIG. 1 illustrates an example of a wireless communications system that supports uplink power control parameter indication for multi-panel transmission in accordance with aspects of the present disclosure.

FIG. 2 illustrates an example of a wireless communications system that supports uplink power control parameter indication for multi-panel transmission in accordance with aspects of the present disclosure.

FIG. 3 illustrates an example of a control message that supports uplink power control parameter indication for multi-panel transmission in accordance with aspects of the present disclosure.

FIG. 4 illustrates an example of a control message that supports uplink power control parameter indication for multi-panel transmission in accordance with aspects of the present disclosure.

FIGS. 5A and 5B illustrate examples of control messages that support uplink power control parameter indication for multi-panel transmission in accordance with aspects of the present disclosure.

FIG. 6 illustrates an example of a control message that supports uplink power control parameter indication for multi-panel transmission in accordance with aspects of the present disclosure.

FIGS. 7A and 7B illustrate examples of a control messages that support uplink power control parameter indication for multi-panel transmission in accordance with aspects of the present disclosure.

FIGS. 8A and 8B illustrate examples of control message that support uplink power control parameter indication for multi-panel transmission in accordance with aspects of the present disclosure.

FIG. 9 illustrates an example of an architecture that supports uplink power control parameter indication for multi-panel transmission in accordance with aspects of the present disclosure.

FIGS. 10 and 11 show block diagrams of devices that support uplink power control parameter indication for multi-panel transmission in accordance with aspects of the present disclosure.

FIG. 12 shows a block diagram of a communications manager that supports uplink power control parameter indication for multi-panel transmission in accordance with aspects of the present disclosure.

FIG. 13 shows a diagram of a system including a device that supports uplink power control parameter indication for multi-panel transmission in accordance with aspects of the present disclosure.

FIGS. 14 and 15 show block diagrams of devices that support uplink power control parameter indication for multi-panel transmission in accordance with aspects of the present disclosure.

FIG. 16 shows a block diagram of a communications manager that supports uplink power control parameter indication for multi-panel transmission in accordance with aspects of the present disclosure.

FIG. 17 shows a diagram of a system including a device that supports uplink power control parameter indication for multi-panel transmission in accordance with aspects of the present disclosure.

FIGS. 18 through 22 show flowcharts illustrating methods that support uplink power control parameter indication for multi-panel transmission in accordance with aspects of the present disclosure.

### DETAILED DESCRIPTION

Some wireless communication systems may include communication devices, such as user equipments (UEs) and base stations, for example, eNodeBs (eNBs), next-generation NodeBs or giga-NodeBs (either of which may be referred to as a gNB) that may support multiple radio access technologies. Examples of radio access technologies include 4G systems such as Long Term Evolution (LTE) systems and fifth generation (5G) systems which may be referred to as New Radio (NR) systems. The communication devices may, in some examples, support one or more of the above example radio access technologies. In some wireless communications systems a UE may use a control message (such as a medium access control (MAC) control element) to map transmission configuration indicator states to one or more codepoints. However, current MAC control elements do not provide for indicating or updating uplink power control parameters.

One or more aspects of the present disclosure provides for jointly updating an uplink transmission configuration indicator and uplink power control parameter for a single physical downlink control channel scheduling physical uplink shared channel from multiple transmission and/or reception points. In some examples, a UE may receive a control message associated with an uplink transmission from one or more antenna panels. In some cases, the control message may include a first indication associated with an uplink transmission configuration indicator and a second indication of an uplink power control parameter set identifier associated with the first indication. The control message may indicate a first activated uplink transmission configuration indicator state identifier for a codepoint associated with a first antenna panel and a second activated uplink transmission configuration indicator state identifier for the codepoint associated with a second antenna panel. The control message may further indicate a first uplink power control parameter set identifier associated with the first activated uplink transmission configuration indicator state identifier and a second uplink power control parameter set identifier associated with the second activated uplink transmission configuration indicator state identifier. Thus, the control message may provide for a mapping between an activated uplink transmission configuration indicator state identifier and a corresponding uplink power control parameter set identifier.

Additionally or alternatively, one or more aspects of the present disclosure provides for separately updating an uplink transmission configuration indicator and uplink power control parameter for a single physical downlink control channel scheduling physical uplink shared channel from multiple transmission and/or reception points. For example, the UE may receive a control message associated with an uplink transmission from one or more antenna panels, the control message including a bit, where a value of the bit indicates whether an uplink transmission configuration indicator is included in the control message or an uplink power control parameter set identifier is included in the control message.

Additionally or alternatively, one or more aspects of the present disclosure provides for jointly updating an uplink transmission configuration indicator and uplink power control parameter for multiple physical downlink control channels scheduling physical uplink shared channel from multiple transmission and/or reception points. In such an example, the control message may include a control resource set (CORESET) pool identifier, where a value of the CORESET pool identifier indicates a downlink control information associated with the control message.

UEs capable of supporting uplink power control parameter indication for multi-panel transmission may utilize the techniques described herein to experience power saving, such as reduced power consumption and extended battery life while ensuring reliable and efficient communications between UEs and base stations. Particular aspects of the subject matter described in this disclosure may be implemented to realize one or more of the following potential advantages. The techniques employed by the described UEs may provide benefits and enhancements to the operation of the UEs. For example, operations performed by the UEs may provide improvements to wireless operations. In some examples, the UEs may support high reliability and low latency communications, among other examples, in accordance with aspects of the present disclosure. The described techniques may thus include features for improvements to power consumption, spectral efficiency, higher data rates and, in some examples, may promote enhanced efficiency for high reliability and low latency operations, among other benefits.

Aspects of the disclosure are initially described in the context of wireless communications systems. Aspects of the disclosure are illustrated by and described with reference to control messages. Aspects of the disclosure are further illustrated by and described with reference to apparatus diagrams, system diagrams, and flowcharts that relate to uplink power control parameter indication for multi-panel transmission.

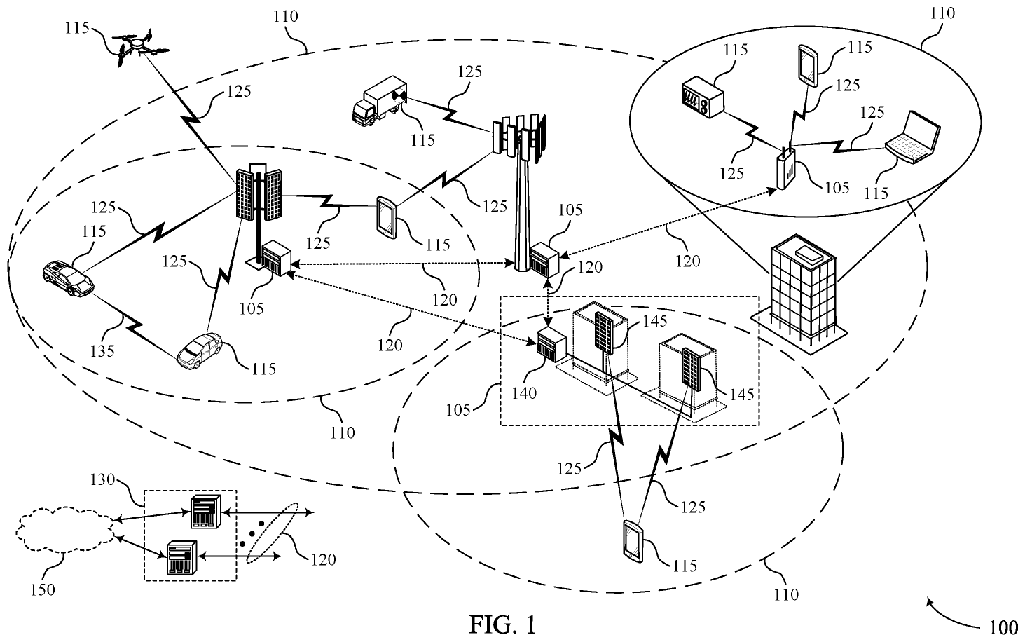

FIG. 1 illustrates an example of a wireless communications system 100 that supports uplink power control parameter indication for multi-panel transmission in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some wireless communications systems a UE may receive a control message (such as a MAC control element), and the UE may use the command to map up to eight transmission configuration indicator states to one or more codepoints. However, current MAC control elements do not provide for indicating or updating uplink power control parameters.

One or more aspects of the present disclosure provides for jointly updating an uplink transmission configuration indicator and uplink power control parameter for a single physical downlink control channel scheduling physical uplink shared channel from multiple transmission and/or reception points. For example, a UE 115 may receive, from a base station 105, a control message associated with an uplink transmission from one or more antenna panels. In some cases, the control message may include a first indication associated with an uplink transmission configuration indicator and a second indication of an uplink power control parameter set identifier associated with the first indication.

Additionally or alternatively, one or more aspects of the present disclosure provides for separately updating an uplink transmission configuration indicator and uplink power control parameter for a single physical downlink control channel scheduling physical uplink shared channel from multiple transmission and/or reception points. For example, the UE 115 may receive a control message associated with an uplink transmission from one or more antenna panels, the control message including a bit, where a value of the bit indicates whether an uplink transmission configuration indicator is included in the control message or an uplink power control parameter set identifier is included in the control message.

Additionally or alternatively, one or more aspects of the present disclosure provides for jointly updating an uplink transmission configuration indicator and uplink power control parameter for multiple physical downlink control channels scheduling physical uplink shared channel from multiple transmission and/or reception points. In such an example, the UE 115 may receive a control message associated with an uplink transmission, the control message may include a CORESET pool identifier, where a value of the CORESET pool identifier indicates a downlink control information associated with the control message.

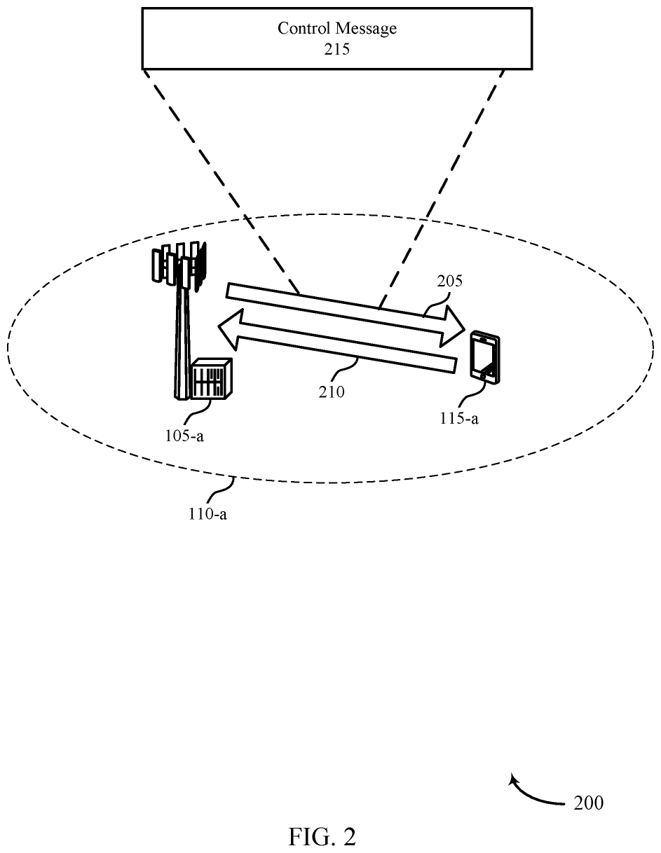

FIG. 2 illustrates an example of a wireless communications system 200 that supports uplink power control parameter indication for multi-panel transmission in accordance with aspects of the present disclosure. In some examples, the wireless communications system 200 may implement aspects of the wireless communications system 100. Wireless communications system 200 includes base station 105-a and UE 115-a, which may be examples of the corresponding devices described with reference to FIG. 1. Base station 105-a may communicate with wireless devices (including UE 115-a) within coverage area 110-a. For example, base station 105-a may transmit downlink signals to UE 115-a on resources of a carrier 205, and UE 115-a may transmit uplink signals to base station 105-a on resources of a carrier 210. Wireless communications system 200 may support communication between base station 105-a and UE 115-a using various antenna configurations, as described with reference to wireless communications system 100. Aspects of the present disclosure provides for various methods of indicating uplink power control parameter for multi-panel transmission.

In some wireless communications systems, uplink transmission configuration indicator states may be set according to Table 1:

TABLE 1

| Valid UL- | | | |
|---|---|---|---|
| TCI state | | (target) | |
| Configuration | Source (reference) RS | UL RS | [qcl-Type ] |
| 1 | SRS resource (for BM) + | DM-RS for | Spatial-relation |
| | [panel ID] | PUCCH or SRS | |
| | | or PRACH | |
| 2 | DL RS(a CSI-RS resource | DM-RS for | Spatial-relation |
| | or a SSB) + [panel ID] | PUCCH or SRS | |
| | | or PRACH | |
| 3 | DL RS(a CSI-RS resource | DM-RS for | Spatial- |
| | or a SSB) + [panel ID] | PUSCH | relation + |
| | | | [port(s)- |
| | | | indication] |
| 4 | DL RS(a CSI-RS resource | DM-RS for | Spatial- |
| | or a SSB) and SRS | PUSCH | relation + |
| | resource + [panel ID] | | [port(s)- |
| | | | indication] |
| 5 | SRS resource + [panel ID] | DM-RS for | Spatial- |
| | | PUSCH | relation + |
| | | | [port(s)- |
| | | | indication] |
| 6 | UL RS(a SRS for BM) | DM-RS for | Spatial- |
| | and SRS resource + | PUSCH | relation + |
| | [panel ID] | | [port(s)- |
| | | | indication] |

In some wireless communications systems a UE may receive a command (such as a MAC control element command), and the UE may use the command to map up to eight transmission configuration indicator states to one or more codepoints of a downlink control information field “Transmission Configuration Indication.” In some examples, a UE may receive an indication for a transmission configuration indicator for a physical uplink shared channel. In some cases, a demodulation reference signal and a physical uplink shared channel may use the same uplink transmission configuration indicator state. In some cases, a channel state information reference signal, a synchronization signal block or a sounding reference signal may be used as a reference signal in the transmission configuration indicator state. In some examples, radio resource control may configure one or more transmission configuration indicator states. For instance, the radio resource control may configure up to 128 states for the transmission configuration indicator. However, a downlink control information is unable to indicate more than a specific number of transmission configuration indicator states. In some examples, UE specific MAC control element may to select a few transmission configuration indicator states (e.g., up to eight transmission configuration indicator states). In some cases, a downlink control information may include three bits and each combination of bits may indicate one of the eight transmission configuration indicator states.

In some examples, power control for physical uplink shared channel may be calculated using the equation (1) (Subject to maximum transmit power limit). If a UE transmits a physical uplink shared channel on active UL BWP b of carrier f of serving cell c using parameter set configuration with index j and physical uplink shared channel power control adjustment state with index l, then the UE may determine the PUSCH transmission power in PUSCH transmission occasion i as

$${P}_{PUSCH} ( i , j , {q}_{d} , l ) = min ( \begin{matrix}{P}_{cmax , f , c ( i )} \\ {P}_{{o}_{PUSCH} , b , f , c} ( j ) + 10 {log}_{10} ( {2}^{μ} {M}_{RB , b , f , c}^{PUSCH} ( i ) ) + {α}_{b , f , c ,} ( j ) {PL}_{b , f , c} ( {q}_{d} ) + {Δ}_{TF , f , c} ( i ) + {f}_{b , f , c} ( i , j , l )\end{matrix} ) \qquad ( 1 )$$

P_{O}_{_{PUSCH}}_{,b,f,c} is the target SINR determined by P0 value
M_{RB,b,f,c}^{PUSCH}(i) is the bandwidth of the PUSCH resource assignment expressed in number of resource blocks for PUSCH transmission
α_{b,f,c,} is path loss compensation factor
PL_{b,f,c} is path loss downlink RS
Δ_{TF,f,c} is MCS related adjustment
f_{b,f,c} is the PUSCH power control adjustment state with closeloopindex l

In some cases, power control for physical uplink shared channel may be based on ULPC_para_set. The ULPC_pare_set may be identified as SRI-PUSCH-PowerControl. The ULPC_para_set may contain any of a P0 value, a pathloss downlink RS, and a closeloopindex, and a path loss compensation factor. The example of SRI-PUSCH-power control can be as follows:

| | |
|---|---|
| SRI-PUSCH-PowerControl ::= | SEQUENCE { |
| sri-PUSCH-PowerControlId | SRI-PUSCH-PowerControlId, |
| sri-PUSCH-PathlossReferenceRS-Id | PUSCH-PathlossReferenceRS-Id, |
| sri-P0-PUSCH-AlphaSetId | P0-PUSCH-AlphaSetId, |
| sri-PUSCH-ClosedLoopIndex | ENUMERATED { i0, i1 } |

}

where sri-PUSCH-ClosedLoopIndex provides a closeloopindex, sri-P0-PUSCH-AlphaSetId identifies a P0 value and a path loss compensation factor, sri-PUSCH-PathlossReferenceRS-Id identifies a path loss downlink reference signal, and sri-PUSCH-PowerControlId is an identity for the power control parameter set. Some wireless communications systems do not provide for selection of uplink power control parameter by a MAC control element.

One or more aspects of the present disclosure provides for jointly updating an uplink transmission configuration indicator and uplink power control parameter for a single physical downlink control channel scheduling physical uplink shared channel from multiple transmission and/or reception points, e.g., from multiple uplink antenna panels or antenna port groups. Additionally or alternatively, one or more aspects of the present disclosure provides for separately updating an uplink transmission configuration indicator and uplink power control parameter for a single physical downlink control channel scheduling physical uplink shared channel from multiple transmission and/or reception points, e.g., from multiple uplink antenna panels or antenna port groups. Additionally or alternatively, one or more aspects of the present disclosure provides for jointly updating an uplink transmission configuration indicator and uplink power control parameter for multiple physical downlink control channels scheduling physical uplink shared channel from multiple transmission and/or reception points, e.g., from multiple uplink antenna panels or antenna port groups.

In the example of FIG. 2, the base station 105-a transmits a control message 215 to the UE 115-a. The control message may be associated with an uplink transmission from one or more antenna panels. The antenna panels can also be referred, but not limited to, as antenna port groups or antenna sets. In some cases, the control message may include a first indication associated with an uplink transmission configuration indicator and a second indication of an uplink power control parameter set identifier associated with the first indication. The UE 115-a may then communicate with the base station 105-a based on the first indication associated with the uplink transmission configuration indicator and the second indication of the uplink power control parameter set identifier.

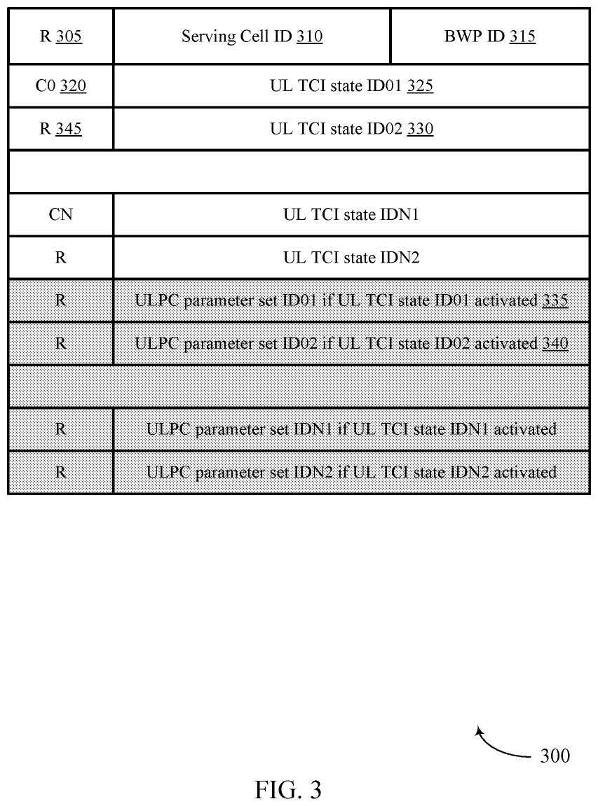

FIG. 3 illustrates an example of a control message 300 that supports uplink power control parameter indication for multi-panel transmission in accordance with aspects of the present disclosure. In some examples, the control message 300 may implement aspects of the wireless communications system 100 as depicted with reference to FIG. 1 and the wireless communications system 200 as depicted with reference to FIG. 2. The control message 300 may be an example of a MAC control element.

According to one or more aspects, the control message 300 may support jointly updating an uplink transmission configuration indicator and uplink power control parameter for a single physical downlink control channel scheduling physical uplink shared channel from multiple transmission and/or reception points (e.g., antenna panels, or antenna port groups). In some examples, a receiving device (such as a UE) may receive, from a base station, a control message associated with an uplink transmission from one or more antenna panels. The control message may include a first indication associated with an uplink transmission configuration indicator and a second indication of an uplink power control parameter set identifier associated with the first indication. As depicted herein, the UE may receive the control message 300 from the base station.

In some examples, the UE may receive a downlink control information. The downlink control information may indicate a value for a codepoint. For example, the downlink control information may indicate the value for the codepoint in a downlink control information “Transmission Configuration Indication” field. The control message 300 may update the configured one or two transmission configuration indicator states for the codepoint of the downlink control information “Transmission Configuration Indication” field for physical uplink shared channel of a serving cell. In the example of FIG. 3, TCI state IDi,j denotes the jth transmission configuration indicator state indicated for the ith codepoint in the uplink downlink control information “Transmission Configuration Indication” field. In some examples, the transmission configuration indication codepoint to which the transmission configuration indication states are mapped, may be determined by its ordinal position among all the transmission configuration indication states with sets of transmission configuration indication state IDi,j fields. In some examples, up to eight transmission configuration indication states may be selected for a single panel transmission. Additionally or alternatively, up to eight pairs of transmission configuration indication states may be selected for a multi-panel transmission. In some cases, a maximum number of activated transmission configuration indication codepoint may be eight and the maximum number of transmission configuration indication states mapped to a transmission configuration indication codepoint may be two. In the example of FIG. 3, Cn=0 indicates one transmission configuration indication, and Cn=1 indicates two transmission configuration indications activated for a transmission configuration indication codepoint.

The control message 300 may include a reserved bit 305, a serving cell identifier 310 and a BWP identifier 315. In some examples, a downlink control information may schedule two physical uplink shared channels. For instance, in control message 300, two rows may correspond to a first codepoint. In some examples, the uplink downlink control information may indicate a codepoint “000” for a physical uplink shared channel. The field C0 320 in the control message 300 may include an indication of the codepoint “000.” For a multi-panel transmission, the reserved bit 345 may include an indication of the codepoint “000” for another antenna panel. Additionally, the control message 300 may indicate uplink transmission configuration indicator state identifiers for the codepoint. In the example of FIG. 3, the control message 300 may indicate a first activated uplink transmission configuration indicator state identifier 325 for the codepoint (indicated via C0) associated with a first antenna panel and a second activated uplink transmission configuration indicator state identifier 330 for the codepoint associated with a second antenna panel if C0 is set to 1. For each uplink transmission configuration indicator state identifier, the control message may provide for an indication of an associated uplink power control parameter set identifier. For example, the control message may include a first uplink power control parameter set identifier 335 associated with the first activated uplink transmission configuration indicator state identifier 325 and a second uplink power control parameter set identifier 340 associated with the second activated uplink transmission configuration indicator state identifier 330. That is, if UL TCI state ID01 is activated, the control message may indicate ULPC parameter set ID01 associated with UL TCI state ID01. Similarly, if UL TCI state ID02 (e.g., a uplink transmission configuration indicator state identifier associated with the same codepoint as UL TCI state ID01 but different antenna panel) is activated, the control message may indicate ULPC parameter set ID02 associated with UL TCI state ID02. Thus, the control message 300 may provide for a one-to-one mapping between activated uplink transmission configuration indicator state identifiers and uplink power control parameter set identifiers. The UE may communicate with the base station based on the control message 300. For instance, the UE may communicate with the base station based on the first indication associated with the uplink transmission configuration indicator (e.g., UL TCI state ID01 and/or UL TCI state ID02) and the second indication of the uplink power control parameter set identifier (e.g., ULPC parameter set ID01 and/or ULPC parameter set ID02).

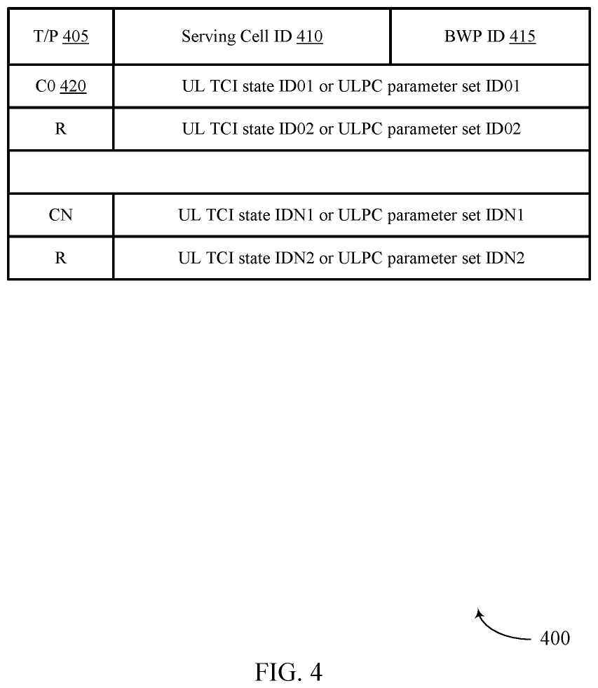

FIG. 4 illustrates an example of a control message 400 that supports uplink power control parameter indication for multi-panel transmission in accordance with aspects of the present disclosure. In some examples, the control message 400 may implement aspects of the wireless communications system 100 as depicted with reference to FIG. 1 and the wireless communications system 200 as depicted with reference to FIG. 2. The control message 400 may be an example of a MAC control element.

According to one or more aspects, the control message 400 may support separately updating an uplink transmission configuration indicator and uplink power control parameter for a single physical downlink control channel scheduling physical uplink shared channel from multiple transmission and/or reception points (e.g., antenna panels). As described herein, the physical uplink shared channel may be one or more of time division multiplexed, frequency division multiplexed, or space division multiplexed. In some examples, a receiving device (such as a UE) may receive, from a base station, a control message associated with an uplink transmission from one or more antenna panels. The control message may include a bit, where a value of the bit indicates whether an uplink transmission configuration indicator is included in the control message or an uplink power control parameter set identifier is included in the control message. As depicted herein, the UE may receive the control message 400 from the base station.

In some examples, the UE may receive a downlink control information after receiving the control message. The downlink control information may indicate a value for a codepoint. In some examples, the uplink transmission configuration indicator included in the control message 400 may be associated with the codepoint. In some examples, the downlink control information may indicate the value for the codepoint in a downlink control information “Transmission Configuration Indication” field. The control message 400 may include an indication of the codepoint in the field C0 420. The control message 400 may include a T/P bit 405 configured to indicate whether the control message is intended to indicate an uplink transmission configuration or an uplink power control parameter set identifier. The control message 400 may further indicate a serving cell identifier 410 and a BWP identifier 415. In some examples, a downlink control information may schedule two physical uplink shared channels. For instance, in control message 400, two rows may correspond to a first codepoint if C0 is set to 1. Each row of the two rows may be associated with a different antenna panel if the corresponding bit Cn (n=0, . . . N) is set to 1.

In some cases, if the value of the T/P bit is 1, the control message 400 may be configured to indicate uplink transmission configuration indicator state identifiers. In the example of FIG. 4, the control message 400 may indicate a first uplink transmission configuration indicator state identifier (or UL TCI state ID01) for the codepoint associated with a first antenna panel and a second uplink transmission configuration indicator state identifier (or UL TCI state ID02) for the codepoint associated with a second antenna panel. Alternatively, if the value of the T/P bit is 0, the control message 400 may be configured to indicate uplink power control parameter set identifiers. In some cases, the control message 400 may indicate a first uplink power control parameter set identifier (or ULPC parameter set ID01) for the codepoint associated with the first antenna panel and a second uplink power control parameter set identifier (or ULPC parameter set ID02) for the codepoint associated with the second antenna panel. In some examples, the uplink power control parameter set identifier may include a uplink power control parameter set identifier or a SRI_PUSCH_powercontrolId.

The UE may communicate with the base station based on the control message 400. More specifically, the UE may communicate with the base station based on the T/P bit 405. For instance, if the T/P bit 405 indicates a value one, then the UE may communicate with the base station based on the uplink transmission configuration indicator (e.g., UL TCI state ID01 and/or UL TCI state ID02). Alternatively, if the T/P bit 405 indicates a value zero, then the UE may communicate with the base station based on the uplink power control parameter set identifier (e.g., ULPC parameter set ID01 and/or ULPC parameter set ID02).

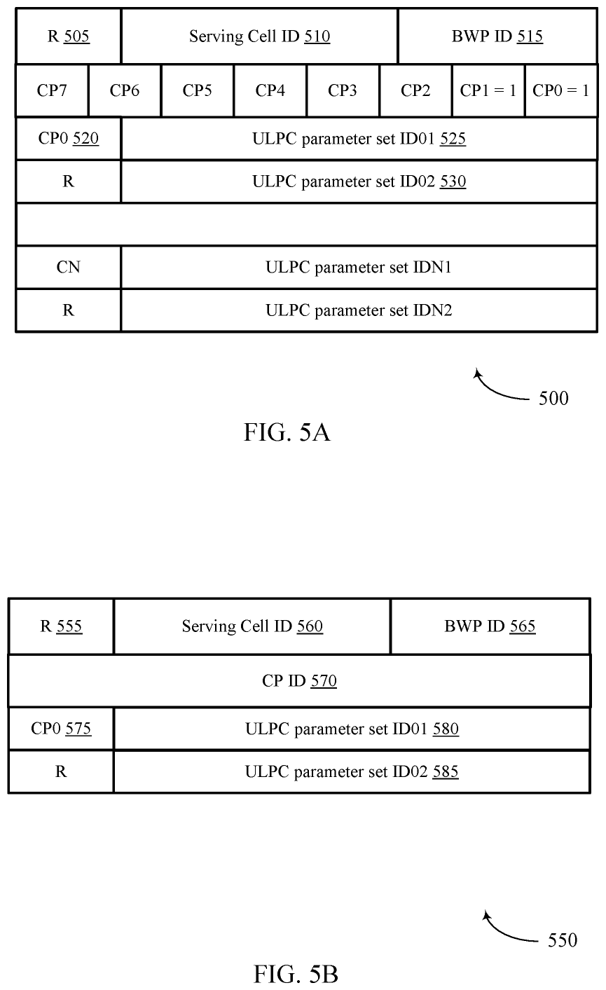

FIGS. 5A and 5B illustrate examples of control message 500 and control message 550 that supports uplink power control parameter indication for multi-panel transmission in accordance with aspects of the present disclosure. In some examples, the control message 500 and the control message 550 may implement aspects of the wireless communications system 100 as depicted with reference to FIG. 1 and the wireless communications system 200 as depicted with reference to FIG. 2. In some examples, the control message 500 may be an example of a MAC control element.

According to one or more aspects, the control message 500 may support updating uplink power control indications per transmission configuration indicator codepoint for a single physical downlink control channel scheduling physical uplink shared channel from multiple antenna panels. As described herein, the physical uplink shared channel may be one or more of time division multiplexed, frequency division multiplexed, or space division multiplexed. In some examples, a receiving device (such as a UE) may receive, from a base station, a control message associated with an uplink transmission from one or more antenna panels. The uplink transmission may include a physical uplink shared channel transmission. As depicted herein, the UE may receive the control message 500 from the base station.

The control message 500 may indicate a reserved bit 505, a serving cell identifier 510 and a BWP identifier 515. The control message 500 may further indicate a bitmap including multiple fields, each field being associated with a codepoint. In the example of FIG. 5A, the bitmap is associated with the codepoints CP0, CP1, CP2, CP3, CP4, CP5, CP6, and CP7. In some cases, one or more fields of the bitmap may be activated. That is, the control message 500 may indicate an activated field in the bitmap indicating a value of a codepoint. In FIG. 5A, the codepoint associated with CP0 is activated (via CP0=1) and the codepoint associated with CP1 is activated (via CP1=1).

In some examples, the UE may identify that two physical uplink shared channels are associated with each codepoint. For instance, in control message 500, two rows may correspond to a first codepoint CP0 and two rows may correspond to a second codepoint CP1. Each row of the two rows may be associated with a different antenna panel. In some cases, the field CP0 520 may indicate that the codepoint associated with CP0 is activated. The control message 500 may indicate a first uplink power control parameter set identifier for a codepoint associated with a first antenna panel and a second uplink power control parameter set identifier for the codepoint associated with a second antenna panel. With respect to the FIG. 5A, the control message 500 may indicate ULPC parameter set ID01 525 for the codepoint CP0 associated with a first antenna panel and ULPC parameter set ID02 530 for the codepoint CP0 associated with a second antenna panel. Although not depicted herein, the control message 500 may indicate a first uplink power control parameter set identifier for the codepoint CP1 associated with a first antenna panel and fourth uplink power control parameter set identifier for the codepoint CP1 associated with a second antenna panel. The UE may communicate with the base station based on the control message 400. More specifically, the UE may communicate with the base station upon identifying one or more uplink power control parameter set identifiers per transmission configuration indicator codepoint.

Referring to FIG. 5B, the UE may receive a control message 550. In some examples, the control message 550 may be an example of a MAC control element. According to one or more aspects, the control message 550 may support updating an uplink power control indication for a single transmission configuration indicator codepoint or a single transmission configuration indicator state for a single physical downlink control channel scheduling physical uplink shared channel from multiple antenna panels. As described herein, the UE may receive, from a base station, a control message associated with an uplink transmission from one or more antenna panels. The uplink transmission may include a physical uplink shared channel transmission. As depicted herein, the UE may receive the control message 550 from the base station.

The control message 550 may indicate a reserved bit 555, a serving cell identifier 560 and a BWP identifier 565. The control message 550 may further indicate a codepoint identifier 570 (or CP ID) associated with a codepoint. Alternatively, the control message 550 may indicate an activated transmission configuration indicator state identifier associated with a codepoint identifier 570 (or CP ID), instead of directly indicating a codepoint identifier. In some examples, the UE may identify that two physical uplink shared channels are associated with each codepoint. For instance, in control message 550, two rows may correspond to a codepoint. That is, two rows may correspond to the codepoint indicated using the codepoint identifier 570. Each row of the two rows may be associated with a different antenna panel. In the example of FIG. 5B, the control message 550 may indicate a first uplink power control parameter set identifier for the codepoint associated with a first antenna panel and a second uplink power control parameter set identifier for the codepoint associated with a second antenna panel. That is, the control message 550 may indicate ULPC parameter set ID01 580 for the codepoint (i.e., the codepoint associated with CP ID 570, or the associated activated transmission configuration indicator state) associated with a first antenna panel and ULPC parameter set ID02 585 for the codepoint associated with a second antenna panel if the bit 575 CP0 is set to one. The UE may communicate with the base station based on the control message 400. More specifically, the UE may then communicate with the base station upon identifying one or more uplink power control parameter set identifiers for a single transmission configuration indicator codepoint.

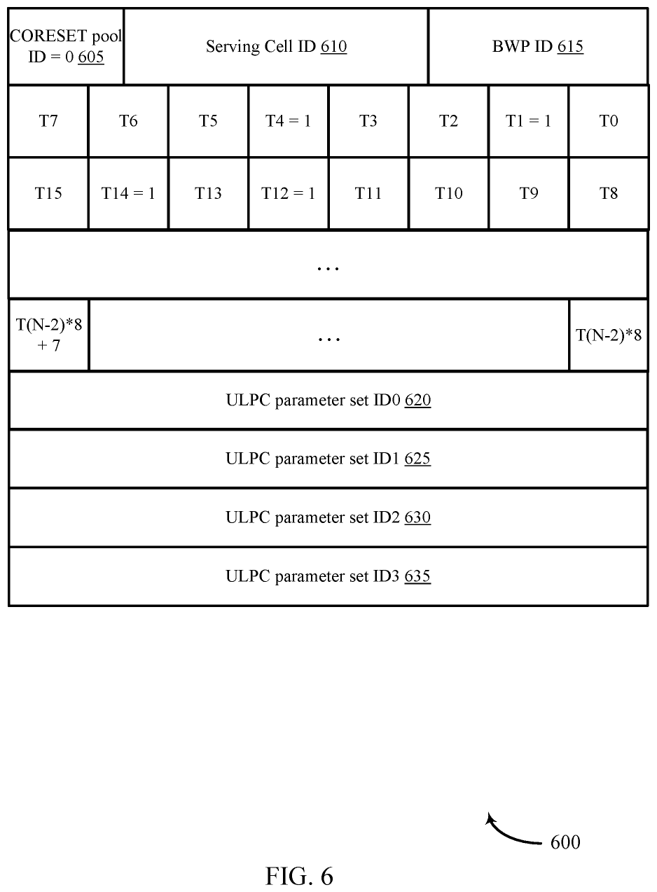

FIG. 6 illustrates an example of a control message 600 that supports uplink power control parameter indication for multi-panel transmission in accordance with aspects of the present disclosure. In some examples, the control message 600 may implement aspects of the wireless communications system 100 as depicted with reference to FIG. 1 and the wireless communications system 200 as depicted with reference to FIG. 2. In some examples, the control message 600 may be an example of a MAC control element.

According to one or more aspects, the control message 600 may support activating and/or deactivating one or more configured transmission configuration indicator states for a physical uplink shared channel of a serving cell (or multiple cells from a cell list that the serving cell belongs to). In some examples, the control message 600 may support jointly updating uplink transmission configuration indicator and uplink power control parameter for multiple physical downlink control channels scheduling physical uplink shared channel from multiple transmission and/or reception points (e.g., antenna panels, or antenna port groups). As described herein, each physical downlink control channel may be associated with a CORESET pool identifier scheduling a physical uplink shared channel from a transmission and/or reception point. In some examples, a receiving device (such as a UE) may receive, from a base station, a control message associated with an uplink transmission from one or more antenna panels. In some examples, the receiving device may also receive a downlink control information after receiving the control message, where the downlink control information indicates a value for a codepoint.

The control message 600 may indicate a CORESET pool identifier 605, a serving cell identifier 610 and a BWP identifier 615. In the example of FIG. 6, a value of the CORESET pool identifier 605 may indicate a downlink control information associated with the control message. That is, the CORESET pool identifier 605 may indicate that the control message 600 may be applied for the physical uplink shared channel scheduled by the physical downlink control channel associated with the CORESET pool identifier 605. The CORESET pool identifier 605 may have a value of 0 or 1 and is respectively associated with two uplink panels for physical uplink shared channel transmission.

The control message 600 may further indicate a bitmap including multiple fields, each field of bit being associated with a transmission configuration indicator state. In the example of FIG. 6, the bitmap is associated with the transmission configuration indicator state T0, T1, T2, T3, T4, T5, T6, T7, T8, T9, T10, T11, T12, T13, T14, T15, up to T(N−2)*8+7. In some cases, one or more fields of the bitmap may be activated. That is, the control message 600 may indicate an activated field in the bitmap indicating an active transmission configuration indicator state. In FIG. 6, the transmission configuration indicator state associated with T1 is activated (via T1=1), the transmission configuration indicator state associated with T4 is activated (via T4=1), the transmission configuration indicator state associated with T12 is activated (via T12=1), and the transmission configuration indicator state associated with T14 is activated (via T14=1). As depicted herein, the codepoint of the downlink control information “Transmission Configuration Indication” field to which the transmission configuration indication state is mapped, may be determined by its ordinal position among all the transmission configuration indication states with Ti field set to 1. In some examples, the maximum number of activated transmission configuration indication states may be 8.

In some examples, the control message 600 may indicate an uplink power control parameter set identifier associated with the active transmission configuration indicator. With respect to the FIG. 6, the control message 600 may indicate ULPC parameter set ID0 620 for the transmission configuration indicator state associated with T1, ULPC parameter set ID1 625 for the transmission configuration indicator state associated with T4, ULPC parameter set ID2 630 for the transmission configuration indicator state associated with T12, and ULPC parameter set ID3 635 for the transmission configuration indicator state associated with T14. In some examples, if the uplink downlink control information associated with the CORESET pool identifier 605 indicates a codepoint “001” for the scheduled physical uplink shared channel, then the UE may assume that the transmission configuration indicator is 4 and the uplink power control parameter set is ULPC para set ID1. The UE may communicate with the base station based on the control message 400. More specifically, the UE may communicate with the base station upon identifying the one or more uplink power control parameter set identifiers.

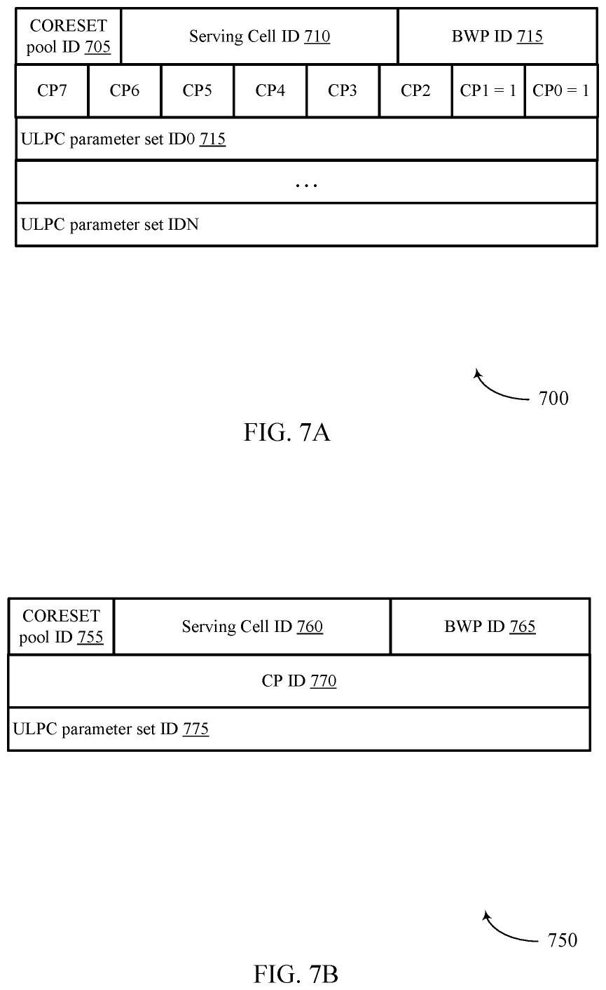

FIGS. 7A and 7B illustrate examples of a control message 700 and a control message 750 that support uplink power control parameter indication for multi-panel transmission in accordance with aspects of the present disclosure. In some examples, the control message 700 and the control message 750 may implement aspects of the wireless communications system 100 as depicted with reference to FIG. 1 and the wireless communications system 200 as depicted with reference to FIG. 2. In some examples, the control message 700 may be an example of a MAC control element.

According to one or more aspects, the control message 700 may support updating uplink power control indications per transmission configuration indicator codepoint for multiple physical downlink control channels scheduling physical uplink shared channel from multiple antenna panels. As described herein, the physical uplink shared channel may be one or more of time division multiplexed, frequency division multiplexed, or space division multiplexed. In some examples, each physical downlink control channel may be associated with a CORESET pool identifier scheduling a physical uplink shared channel from a transmission and/or reception point. As described with reference to FIGS. 3 through 6, a receiving device (such as a UE) may receive, from a base station, a control message associated with an uplink transmission from one or more antenna panels. The uplink transmission may include a physical uplink shared channel transmission.

According to one or more aspects, the UE may receive the control message 700 from the base station. The control message 700 may indicate a CORESET pool identifier 705, a serving cell identifier 710 and a BWP identifier 715. In the example of FIG. 7A, a value of the CORESET pool identifier 705 may indicate a downlink control information associated with the control message. The control message 700 may further indicate a bitmap including multiple fields, each field being associated with a codepoint. In the example of FIG. 7A, the bitmap is associated with the codepoints CP0, CP1, CP2, CP3, CP4, CP5, CP6, and CP7. In some cases, one or more fields of the bitmap may be activated. That is, the control message 700 may indicate an activated field in the bitmap indicating a value of a codepoint. In FIG. 7A, the codepoint associated with CP0 is activated (via CP0=1) and the codepoint associated with CP1 is activated (via CP1=1).

In some examples, the UE may an uplink power control parameter set identifier for a codepoint. With respect to the FIG. 7A, the control message 700 may indicate ULPC parameter set ID0 715 for the codepoint CP0. The control message 700 may also indicate additional uplink power control parameter sets (e.g., ULPC parameter set IDN) for additional activated codepoints (e.g., CP1). The UE may communicate with the base station based on the control message 700.

Referring to FIG. 7B, the UE may receive a control message 750. As described herein, the control message 750 may be an example of a MAC control element. According to one or more aspects, the control message 750 may support updating an uplink power control indication for a single transmission configuration indicator codepoint for multiple physical downlink control channel scheduling physical uplink shared channel from multiple antenna panels. Similar to FIG. 7B, the control message 750 may include a CORESET pool identifier scheduling a physical uplink shared channel from a transmission and/or reception point. The UE may receive, from a base station, a control message associated with an uplink transmission from one or more antenna panels. As depicted herein, the UE may receive the control message 750 from the base station.

The control message 750 may indicate a CORESET pool identifier 755, a serving cell identifier 760 and a BWP identifier 765. In the example of FIG. 7B, a value of the CORESET pool identifier 755 may indicate a downlink control information associated with the control message 750. The control message 750 may further indicate a codepoint identifier 770 (or CP ID) associated with a codepoint. Alternatively, the control message 750 may indicate an activated transmission configuration indicator state identifier associated with a codepoint identifier 770 (or CP ID), instead of directly indicating a codepoint identifier. In some examples, the UE may identify an uplink power control parameter set identifier for the codepoint associated with a codepoint identifier 770 (or the associated activated transmission configuration indicator state). For example, the control message 750 may indicate ULPC parameter set ID 775 the codepoint associated with CP ID 770. The UE may then communicate with the base station upon identifying the uplink power control parameter set identifier (e.g., ULPC parameter set ID 775).

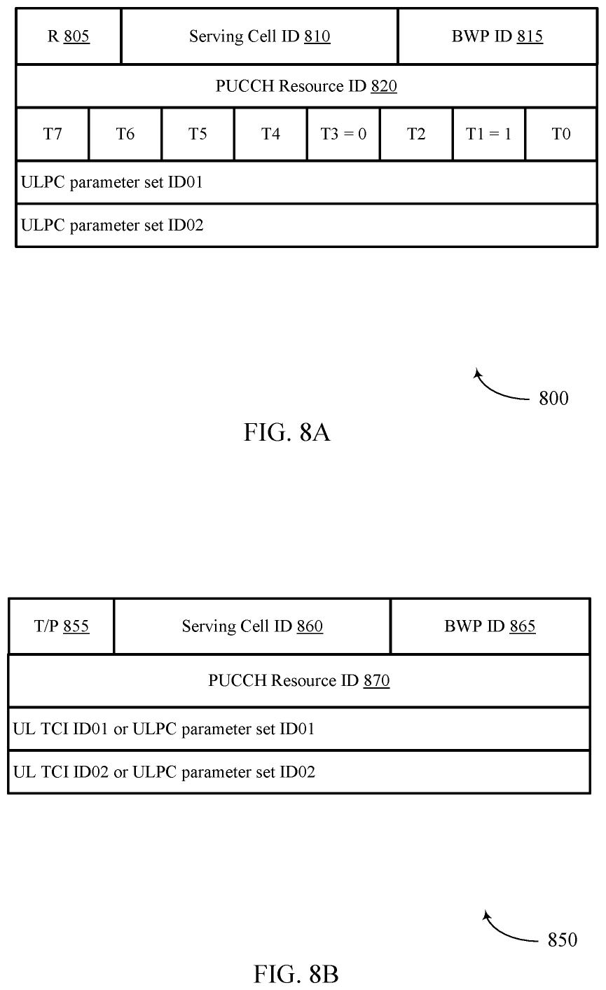

FIGS. 8A and 8B illustrate an example of a control message 800 and a control message 850 that support uplink power control parameter indication for multi-panel transmission in accordance with aspects of the present disclosure. In some examples, the control message 800 and the control message 850 may implement aspects of the wireless communications system 100 as depicted with reference to FIG. 1 and the wireless communications system 200 as depicted with reference to FIG. 2. In some examples, the control message 800 may be an example of a MAC control element.

According to one or more aspects, the control message 800 may support jointly updating uplink transmission configuration indicator and uplink power control parameter for a physical uplink control channel. As described herein, a UE may receive, from a base station, a control message associated with an uplink transmission from one or more antenna panels. The uplink transmission may include a physical uplink control channel transmission. The control message 800 may indicate a reserved bit 805, a serving cell identifier 810 and a BWP identifier 815. The control message 800 may further indicate a physical uplink control channel resource identifier 820.

In some cases, the control message 800 may indicate a bitmap including multiple fields, each field being associated with an uplink transmission configuration indicator. In the example of FIG. 8A, the bitmap is associated with the transmission configuration indicator state T0, T1, T2, T3, T4, T5, T6, and T7. In some cases, one or more fields of the bitmap may be activated. That is, the control message 800 may indicate an activated field in the bitmap indicating an active transmission configuration indicator state. In FIG. 8A, the transmission configuration indicator state associated with T1 is activated (via T1=1), the uplink transmission configuration indicator associated with T1 is activated (via T1=1). In some examples, the control message 800 may indicate an uplink power control parameter set identifier associated with the active transmission configuration indicator. With respect to the FIG. 8A, the control message 800 may indicate ULPC parameter set ID01 for the transmission configuration indicator state associated with T1, and ULPC parameter set ID02 for the transmission configuration indicator state associated with T3. The UE may communicate with the base station based on the control message 400. More specifically, the UE may communicate with the base station upon identifying the one or more uplink power control parameter set identifiers.

Referring to FIG. 8B, the control message 850 may be an example of a MAC control element. According to one or more aspects, the control message 850 may support separately updating an uplink transmission configuration indicator and uplink power control parameter for a physical uplink control channel. In some examples, a receiving device (such as a UE) may receive, from a base station, a control message associated with an uplink transmission from one or more antenna panels. The control message may include a bit, where a value of the bit indicates whether an uplink transmission configuration indicator is included in the control message or an uplink power control parameter set identifier is included in the control message. As depicted herein, the UE may receive the control message 850 from the base station.

The control message 850 may include a T/P bit 855 configured to indicate whether the control message is intended to indicate an uplink transmission configuration or an uplink power control parameter set identifier. The control message 850 may further indicate a serving cell identifier 860 and a BWP identifier 865. The control message 850 may further indicate a physical uplink control channel resource identifier 870. In some cases, if the value of the T/P bit is 1, the control message 850 may be configured to indicate uplink transmission configuration indicator state identifiers. In the example of FIG. 8B, the control message 850 may indicate a uplink transmission configuration indicator state identifier (or UL TCI state ID01) and a second uplink transmission configuration indicator state identifier (or UL TCI state ID02). Alternatively, if the value of the T/P bit is 0, the control message 850 may be configured to indicate uplink power control parameter set identifiers. In some cases, the control message 850 may indicate a first uplink power control parameter set identifier (or ULPC parameter set ID01) and a second uplink power control parameter set identifier (or ULPC parameter set ID02). The UE may the communicate with the base station based on the uplink transmission configuration indicator (e.g., UL TCI state ID01 and/or UL TCI state ID02) or the uplink power control parameter set identifier (e.g., ULPC parameter set ID01 and/or ULPC parameter set ID02).

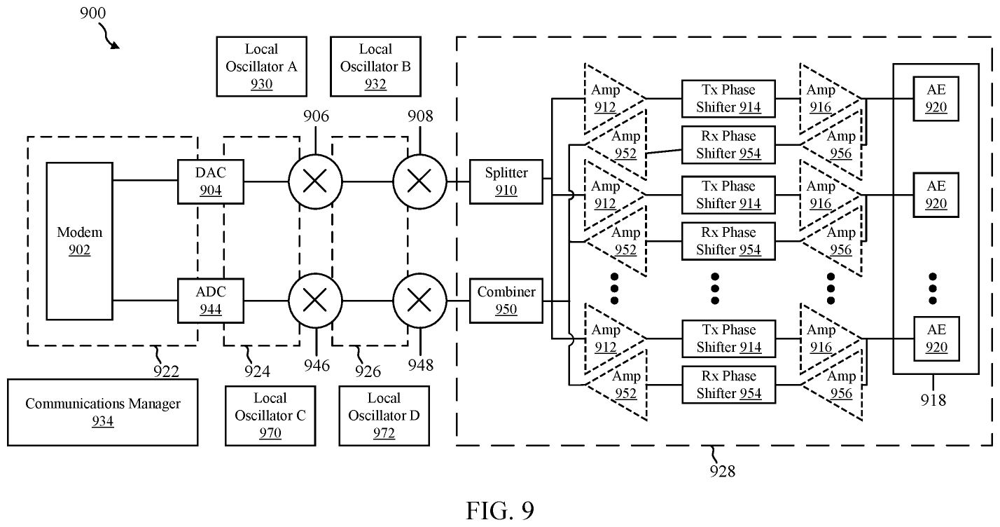

FIG. 9 illustrates an example of an architecture 900 that supports uplink power control parameter indication for multi-panel transmission in accordance with aspects of the present disclosure. In some examples, architecture 900 may implement aspects of wireless communications systems 100 and/or 200. In some aspects, diagram 900 may be an example of the transmitting device (e.g., a first wireless device) and/or a receiving device (e.g., a second wireless device) as described herein.

Broadly, FIG. 9 is a diagram illustrating example hardware components of a wireless device in accordance with certain aspects of the disclosure. The illustrated components may include those that may be used for antenna element selection and/or for beamforming for transmission of wireless signals. There are numerous architectures for antenna element selection and implementing phase shifting, one example of which is illustrated here. The architecture 900 includes a modem (modulator/demodulator) 902, a digital to analog converter (DAC) 904, a first mixer 906, a second mixer 908, and a splitter 910. The architecture 900 also includes a plurality of first amplifiers 912, a plurality of phase shifters 914, a plurality of second amplifiers 916, and an antenna array 918 that includes a plurality of antenna elements 920. Transmission lines or other waveguides, wires, traces, or the like are shown connecting the various components to illustrate how signals to be transmitted may travel between components. Boxes 922, 924, 926, and 928 indicate regions in the architecture 900 in which different types of signals travel or are processed. Specifically, box 922 indicates a region in which digital baseband signals travel or are processed, box 924 indicates a region in which analog baseband signals travel or are processed, box 926 indicates a region in which analog intermediate frequency (IF) signals travel or are processed, and box 928 indicates a region in which analog RF signals travel or are processed. The architecture also includes a local oscillator A 930, a local oscillator B 932, and a communications manager 934.

Each of the antenna elements 920 may include one or more sub-elements (not shown) for radiating or receiving RF signals. For example, a single antenna element 920 may include a first sub-element cross-polarized with a second sub-element that can be used to independently transmit cross-polarized signals. The antenna elements 920 may include patch antennas or other types of antennas arranged in a linear, two dimensional, or other pattern. A spacing between antenna elements 920 may be such that signals with a desired wavelength transmitted separately by the antenna elements 920 may interact or interfere (e.g., to form a desired beam). For example, given an expected range of wavelengths or frequencies, the spacing may provide a quarter wavelength, half wavelength, or other fraction of a wavelength of spacing between neighboring antenna elements 920 to allow for interaction or interference of signals transmitted by the separate antenna elements 920 within that expected range.

The modem 902 processes and generates digital baseband signals and may also control operation of the DAC 904, first and second mixers 906, 908, splitter 910, first amplifiers 912, phase shifters 914, and/or the second amplifiers 916 to transmit signals via one or more or all of the antenna elements 920. The modem 902 may process signals and control operation in accordance with a communication standard such as a wireless standard discussed herein. The DAC 904 may convert digital baseband signals received from the modem 902 (and that are to be transmitted) into analog baseband signals. The first mixer 906 upconverts analog baseband signals to analog IF signals within an IF using a local oscillator A 930. For example, the first mixer 906 may mix the signals with an oscillating signal generated by the local oscillator A 930 to “move” the baseband analog signals to the IF. In some cases, some processing or filtering (not shown) may take place at the IF. The second mixer 908 upconverts the analog IF signals to analog RF signals using the local oscillator B 932. Similarly to the first mixer, the second mixer 908 may mix the signals with an oscillating signal generated by the local oscillator B 932 to “move” the IF analog signals to the RF, or the frequency at which signals will be transmitted or received. The modem 902 and/or the communications manager 934 may adjust the frequency of local oscillator A 930 and/or the local oscillator B 932 so that a desired IF and/or RF frequency is produced and used to facilitate processing and transmission of a signal within a desired bandwidth.

In the illustrated architecture 900, signals upconverted by the second mixer 908 are split or duplicated into multiple signals by the splitter 910. The splitter 910 in architecture 900 splits the RF signal into a plurality of identical or nearly identical RF signals, as denoted by its presence in box 928. In other examples, the split may take place with any type of signal including with baseband digital, baseband analog, or IF analog signals. Each of these signals may correspond to an antenna element 920 and the signal travels through and is processed by amplifiers 912, 916, phase shifters 914, and/or other elements corresponding to the respective antenna element 920 to be provided to and transmitted by the corresponding antenna element 920 of the antenna array 918. In one example, the splitter 910 may be an active splitter that is connected to a power supply and provides some gain so that RF signals exiting the splitter 910 are at a power level equal to or greater than the signal entering the splitter 910. In another example, the splitter 910 is a passive splitter that is not connected to power supply and the RF signals exiting the splitter 910 may be at a power level lower than the RF signal entering the splitter 910.

After being split by the splitter 910, the resulting RF signals may enter an amplifier, such as a first amplifier 912, or a phase shifter 914 corresponding to an antenna element 920. The first and second amplifiers 912, 916 are illustrated with dashed lines because one or both of them might not be necessary in some implementations. In one implementation, both the first amplifier 912 and second amplifier 916 are present. In another, neither the first amplifier 912 nor the second amplifier 916 is present. In other implementations, one of the two amplifiers 912, 916 is present but not the other. By way of example, if the splitter 910 is an active splitter, the first amplifier 912 may not be used. By way of further example, if the phase shifter 914 is an active phase shifter that can provide a gain, the second amplifier 916 might not be used. The amplifiers 912, 916 may provide a desired level of positive or negative gain. A positive gain (positive dB) may be used to increase an amplitude of a signal for radiation by a specific antenna element 920. A negative gain (negative dB) may be used to decrease an amplitude and/or suppress radiation of the signal by a specific antenna element. Each of the amplifiers 912, 916 may be controlled independently (e.g., by the modem 902 or communications manager 934) to provide independent control of the gain for each antenna element 920. For example, the modem 902 and/or the communications manager 934 may have at least one control line connected to each of the splitter 910, first amplifiers 912, phase shifters 914, and/or second amplifiers 916 which may be used to configure a gain to provide a desired amount of gain for each component and thus each antenna element 920.

The phase shifter 914 may provide a configurable phase shift or phase offset to a corresponding RF signal to be transmitted. The phase shifter 914 could be a passive phase shifter not directly connected to a power supply. Passive phase shifters might introduce some insertion loss. The second amplifier 916 could boost the signal to compensate for the insertion loss. The phase shifter 914 could be an active phase shifter connected to a power supply such that the active phase shifter provides some amount of gain or prevents insertion loss. The settings of each of the phase shifters 914 are independent meaning that each can be set to provide a desired amount of phase shift or the same amount of phase shift or some other configuration. The modem 902 and/or the communications manager 934 may have at least one control line connected to each of the phase shifters 914 and which may be used to configure the phase shifters 914 to provide a desired amounts of phase shift or phase offset between antenna elements 920.

In the illustrated architecture 900, RF signals received by the antenna elements 920 are provided to one or more of first amplifier 956 to boost the signal strength. The first amplifier 956 may be connected to the same antenna arrays 918, e.g., for TDD operations. The first amplifier 956 may be connected to different antenna arrays 918. The boosted RF signal is input into one or more of phase shifter 954 to provide a configurable phase shift or phase offset for the corresponding received RF signal. The phase shifter 954 may be an active phase shifter or a passive phase shifter. The settings of the phase shifters 954 are independent, meaning that each can be set to provide a desired amount of phase shift or the same amount of phase shift or some other configuration. The modem 902 and/or the communications manager 934 may have at least one control line connected to each of the phase shifters 954 and which may be used to configure the phase shifters 954 to provide a desired amount of phase shift or phase offset between antenna elements 920.

The outputs of the phase shifters 954 may be input to one or more second amplifiers 952 for signal amplification of the phase shifted received RF signals. The second amplifiers 952 may be individually configured to provide a configured amount of gain. The second amplifiers 952 may be individually configured to provide an amount of gain to ensure that the signal input to combiner 950 have the same magnitude. The amplifiers 952 and/or 956 are illustrated in dashed lines because they might not be necessary in some implementations. In one implementation, both the amplifier 952 and the amplifier 956 are present. In another, neither the amplifier 952 nor the amplifier 956 are present. In other implementations, one of the amplifiers 952, 956 is present but not the other.

In the illustrated architecture 900, signals output by the phase shifters 954 (via the amplifiers 952 when present) are combined in combiner 950. The combiner 950 in architecture combines the RF signal into a signal, as denoted by its presence in box 928. The combiner 950 may be a passive combiner, e.g., not connected to a power source, which may result in some insertion loss. The combiner 950 may be an active combiner, e.g., connected to a power source, which may result in some signal gain. When combiner 950 is an active combiner, it may provide a different (e.g., configurable) amount of gain for each input signal so that the input signals have the same magnitude when they are combined. When combiner 950 is an active combiner, it may not need the second amplifier 952 because the active combiner may provide the signal amplification.

The output of the combiner 950 is input into mixers 948 and 946. Mixers 948 and 946 generally down convert the received RF signal using inputs from local oscillators 972 and 970, respectively, to create intermediate or baseband signals that carry the encoded and modulated information. The output of the mixers 948 and 946 are input into an analog-to-digital converter (ADC) 944 for conversion to analog signals. The analog signals output from ADC 944 is input to modem 902 for baseband processing, e.g., decoding, de-interleaving, etc.

The architecture 900 is given by way of example to illustrate an architecture for transmitting and/or receiving signals. It will be understood that the architecture 900 and/or each portion of the architecture 900 may be repeated multiple times within an architecture to accommodate or provide an arbitrary number of RF chains, antenna elements, and/or antenna panels. Furthermore, numerous alternate architectures are possible and contemplated. For example, although a single antenna array 918 is shown, two, three, or more antenna arrays may be included each with one or more of their own corresponding amplifiers, phase shifters, splitters, mixers, DACs, ADCs, and/or modems. For example, a single UE may include two, four or more antenna arrays for transmitting or receiving signals at different physical locations on the UE or in different directions.

Furthermore, mixers, splitters, amplifiers, phase shifters and other components may be located in different signal type areas (e.g., different ones of the boxes 922, 924, 926, 928) in different implemented architectures. For example, a split of the signal to be transmitted into a plurality of signals may take place at the analog RF, analog IF, analog baseband, or digital baseband frequencies in different examples. Similarly, amplification, and/or phase shifts may also take place at different frequencies. For example, in some contemplated implementations, one or more of the splitter 910, amplifiers 912, 916, or phase shifters 914 may be located between the DAC 904 and the first mixer 906 or between the first mixer 906 and the second mixer 908. In one example, the functions of one or more of the components may be combined into one component. For example, the phase shifters 914 may perform amplification to include or replace the first and/or or second amplifiers 912, 916. By way of another example, a phase shift may be implemented by the second mixer 908 to obviate the need for a separate phase shifter 914. This technique is sometimes called local oscillator phase shifting. In one implementation of this configuration, there may be a plurality of IF to RF mixers (e.g., for each antenna element chain) within the second mixer 908 and the local oscillator B 932 would supply different local oscillator signals (with different phase offsets) to each IF to RF mixer.

The modem 902 and/or the communications manager 934 may control one or more of the other components 904-972 to select one or more antenna elements 920 and/or to form beams for transmission of one or more signals. For example, the antenna elements 920 may be individually selected or deselected for transmission of a signal (or signals) by controlling an amplitude of one or more corresponding amplifiers, such as the first amplifiers 912 and/or the second amplifiers 916. Beamforming includes generation of a beam using a plurality of signals on different antenna elements where one or more or all of the plurality signals are shifted in phase relative to each other. The formed beam may carry physical or higher layer reference signals or information. As each signal of the plurality of signals is radiated from a respective antenna element 920, the radiated signals interact, interfere (constructive and destructive interference), and amplify each other to form a resulting beam. The shape (such as the amplitude, width, and/or presence of side lobes) and the direction (such as an angle of the beam relative to a surface of the antenna array 918) can be dynamically controlled by modifying the phase shifts or phase offsets imparted by the phase shifters 914 and amplitudes imparted by the amplifiers 912, 916 of the plurality of signals relative to each other.

The communications manager 934 may, when architecture 900 is configured as a receiving device, receive, from a base station, a control message associated with an uplink transmission from one or more antenna panels, where the control message includes a first indication associated with an uplink transmission configuration indicator and a second indication of an uplink power control parameter set identifier associated with the first indication. The communications manager 934 may communicate with the base station based on the first indication associated with the uplink transmission configuration indicator and the second indication of the uplink power control parameter set identifier.

The communications manager 934 may, when architecture 900 is configured as a receiving device, receive, from a base station, a control message associated with an uplink transmission from one or more antenna panels, the control message including a bit, where a value of the bit indicates whether an uplink transmission configuration indicator is included in the control message or an uplink power control parameter set identifier is included in the control message. The communications manager 934 may communicate with the base station based on the uplink transmission configuration indicator or the uplink power control parameter set identifier.

The communications manager 934 may, when architecture 900 is configured as a transmitting device, transmit, to a UE, a control message associated with an uplink transmission from one or more antenna panels, where the control message includes a first indication associated with an uplink transmission configuration indicator and a second indication of an uplink power control parameter set identifier associated with the first indication. The communications manager 934 may communicate with the UE based on the first indication associated with the uplink transmission configuration indicator and the second indication of the uplink power control parameter set identifier.

The communications manager 934 may, when architecture 900 is configured as a transmitting device, transmit, to a UE, a control message associated with an uplink transmission from one or more antenna panels, the control message including a bit, where a value of the bit indicates whether an uplink transmission configuration indicator is included in the control message or an uplink power control parameter set identifier is included in the control message. The communications manager 934 may communicate with the UE based on the uplink transmission configuration indicator or the uplink power control parameter set identifier, as discussed herein. The communications manager 934 may be located partially or fully within one or more other components of the architecture 900. For example, the communications manager 934 may be located within the modem 902 in at least one implementation.

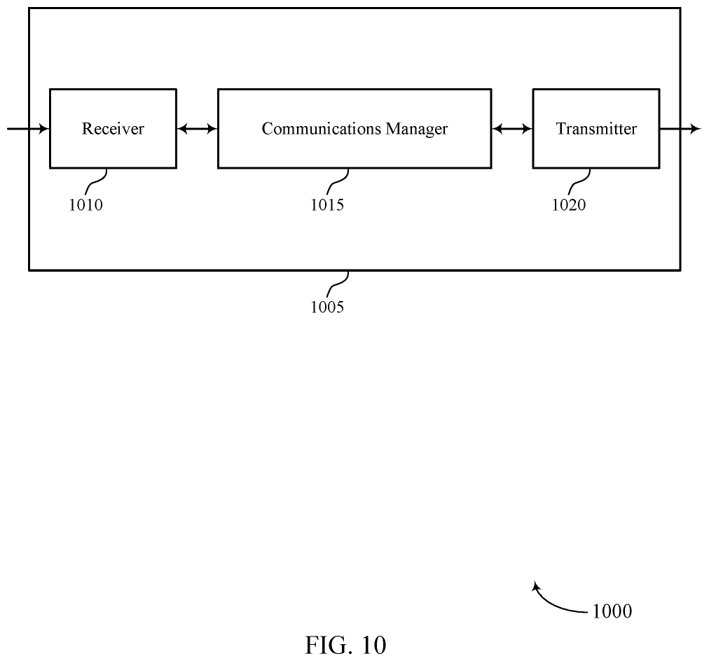

FIG. 10 shows a block diagram 1000 of a device 1005 that supports uplink power control parameter indication for multi-panel transmission in accordance with aspects of the present disclosure. The device 1005 may be an example of aspects of a UE 115 as described herein. The device 1005 may include a receiver 1010, a communications manager 1015, and a transmitter 1020. The device 1005 may also include a processor. Each of these components may be in communication with one another (e.g., via one or more buses).

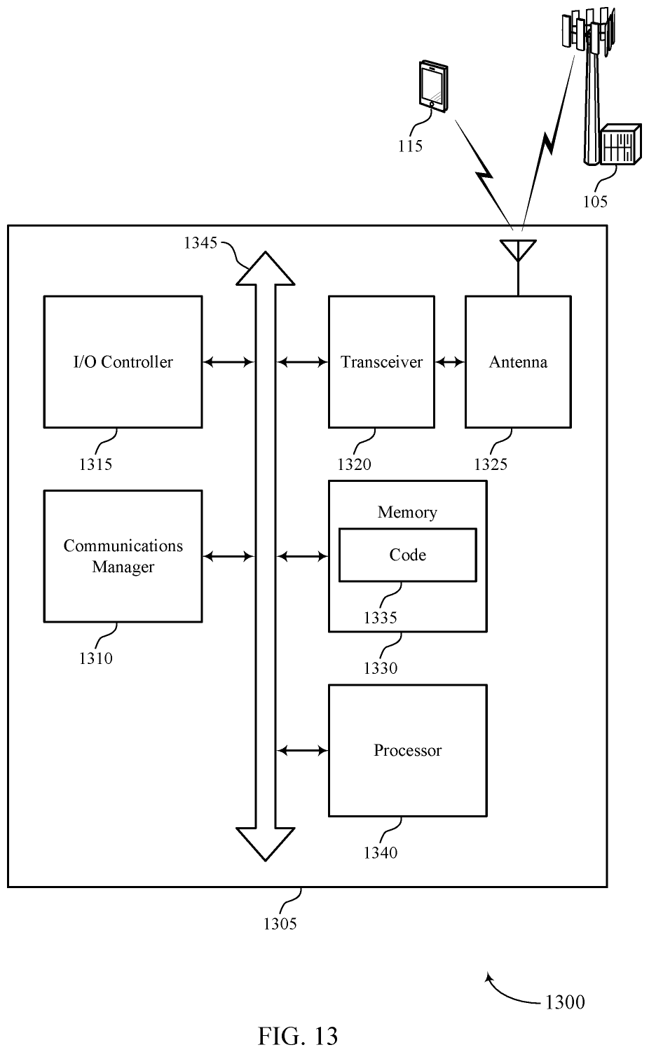

The receiver 1010 may receive information such as packets, user data, or control information associated with various information channels (e.g., control channels, data channels, and information related to uplink power control parameter indication for multi-panel transmission, etc.). Information may be passed on to other components of the device 1005. The receiver 1010 may be an example of aspects of the transceiver 1320 described with reference to FIG. 13. The receiver 1010 may utilize a single antenna or a set of antennas.

The communications manager 1015 may receive, from a base station, a control message associated with an uplink transmission from one or more antenna panels, where the control message includes a first indication associated with an uplink transmission configuration indicator and a second indication of an uplink power control parameter set identifier associated with the first indication and communicate with the base station based on the first indication associated with the uplink transmission configuration indicator and the second indication of the uplink power control parameter set identifier. The communications manager 1015 may also receive, from a base station, a control message associated with an uplink transmission from one or more antenna panels, the control message including a bit, where a value of the bit indicates whether an uplink transmission configuration indicator is included in the control message or an uplink power control parameter set identifier is included in the control message and communicate with the base station based on the uplink transmission configuration indicator or the uplink power control parameter set identifier. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1020 may transmit signals generated by other components of the device 1005. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

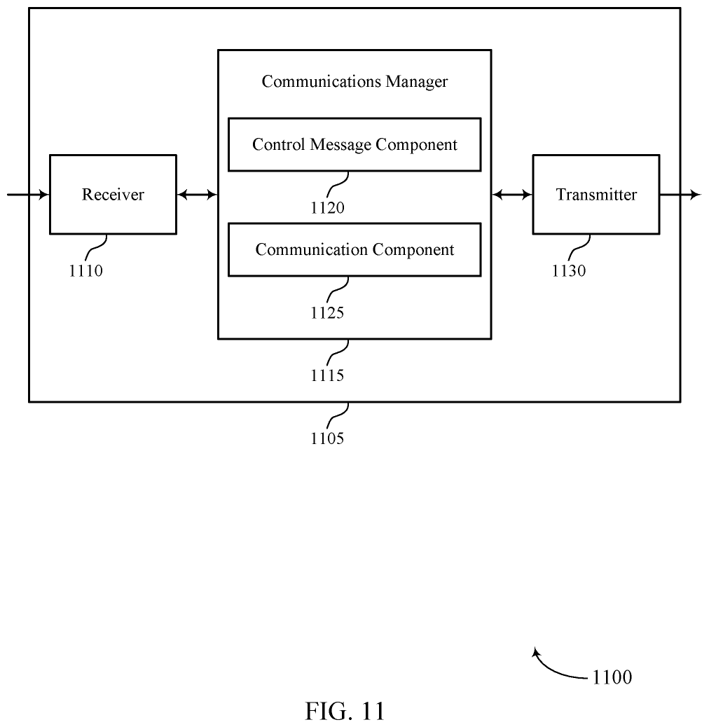

FIG. 11 shows a block diagram 1100 of a device 1105 that supports uplink power control parameter indication for multi-panel transmission in accordance with aspects of the present disclosure. The device 1105 may be an example of aspects of a device 1005, or a UE 115 as described herein. The device 1105 may include a receiver 1110, a communications manager 1115, and a transmitter 1130. The device 1105 may also include a processor. Each of these components may be in communication with one another (e.g., via one or more buses).

The receiver 1110 may receive information such as packets, user data, or control information associated with various information channels (e.g., control channels, data channels, and information related to uplink power control parameter indication for multi-panel transmission, etc.). Information may be passed on to other components of the device 1105. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a control message component 1120 and a communication component 1125. The communications manager 1115 may be an example of aspects of the communications manager 1310 described herein.

The control message component 1120 may receive, from a base station, a control message associated with an uplink transmission from one or more antenna panels, where the control message includes a first indication associated with an uplink transmission configuration indicator and a second indication of an uplink power control parameter set identifier associated with the first indication. The communication component 1125 may communicate with the base station based on the first indication associated with the uplink transmission configuration indicator and the second indication of the uplink power control parameter set identifier.

The control message component 1120 may receive, from a base station, a control message associated with an uplink transmission from one or more antenna panels, the control message including a bit, where a value of the bit indicates whether an uplink transmission configuration indicator is included in the control message or an uplink power control parameter set identifier is included in the control message. The communication component 1125 may communicate with the base station based on the uplink transmission configuration indicator or the uplink power control parameter set identifier.

The transmitter 1130 may transmit signals generated by other components of the device 1105. In some examples, the transmitter 1130 may be collocated with a receiver 1110 in a transceiver module. For example, the transmitter 1130 may be an example of aspects of the transceiver 1320 described with reference to FIG. 13. The transmitter 1130 may utilize a single antenna or a set of antennas.

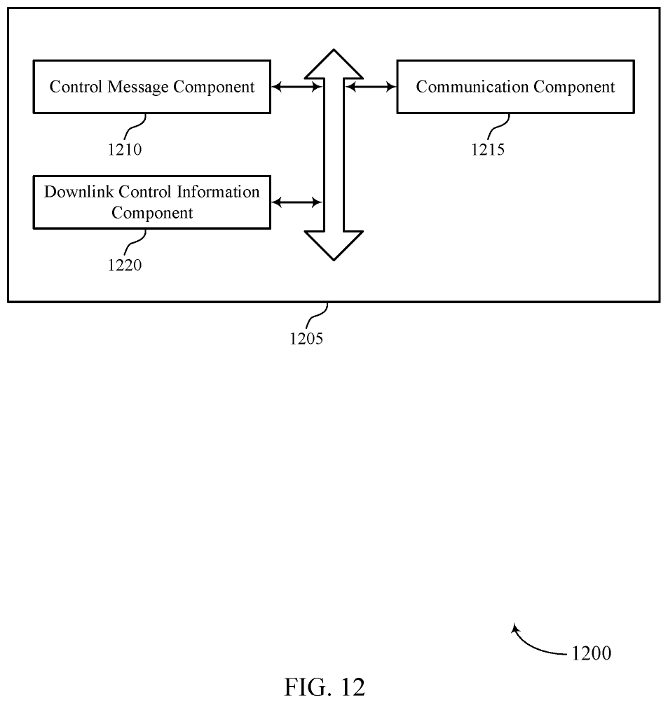

FIG. 12 shows a block diagram 1200 of a communications manager 1205 that supports uplink power control parameter indication for multi-panel transmission in accordance with aspects of the present disclosure. The communications manager 1205 may be an example of aspects of a communications manager 1015, a communications manager 1115, or a communications manager 1310 described herein. The communications manager 1205 may include a control message component 1210, a communication component 1215, and a downlink control information component 1220. Each of these modules may communicate, directly or indirectly, with one another (e.g., via one or more buses).

The control message component 1210 may receive, from a base station, a control message associated with an uplink transmission from one or more antenna panels, where the control message includes a first indication associated with an uplink transmission configuration indicator and a second indication of an uplink power control parameter set identifier associated with the first indication.

In some examples, the control message component 1210 may receive, from a base station, a control message associated with an uplink transmission from one or more antenna panels, the control message including a bit, where a value of the bit indicates whether an uplink transmission configuration indicator is included in the control message or an uplink power control parameter set identifier is included in the control message. In some cases, the first indication associated with the uplink transmission configuration indicator includes an uplink transmission configuration indicator state identifier for the codepoint.

The communication component 1215 may communicate with the base station based on the first indication associated with the uplink transmission configuration indicator and the second indication of the uplink power control parameter set identifier. In some examples, the communication component 1215 may communicate with the base station based on the uplink transmission configuration indicator or the uplink power control parameter set identifier.

The downlink control information component 1220 may receive, from the base station, a downlink control information after receiving the control message, where the downlink control information indicates a value for a codepoint. In some examples, the downlink control information component 1220 may receive, from the base station, a downlink control information after receiving the control message, where the downlink control information indicates a value for a codepoint.

In some cases, the downlink control information schedules a physical uplink shared channel from the first antenna panel and the second antenna panel. In some cases, the physical uplink shared channel is one or more of time division multiplexed, frequency division multiplexed, or space division multiplexed.

In some cases, the uplink transmission configuration indicator is associated with the codepoint. In some cases, the downlink control information schedules a physical uplink shared channel from the first antenna panel and the second antenna panel. In some cases, the physical uplink shared channel is one or more of time division multiplexed, frequency division multiplexed, or space division multiplexed.

In some cases, the first indication associated with the uplink transmission configuration indicator includes a first activated uplink transmission configuration indicator state identifier for the codepoint associated with a first antenna panel and a second activated uplink transmission configuration indicator state identifier for the codepoint associated with a second antenna panel.

In some cases, the second indication of the uplink power control parameter set identifier includes a first uplink power control parameter set identifier associated with the first activated uplink transmission configuration indicator state identifier and a second uplink power control parameter set identifier associated with the second activated uplink transmission configuration indicator state identifier.

In some cases, the control message includes a third indication of the codepoint. In some cases, the first indication associated with the uplink transmission configuration indicator includes a bitmap including multiple fields, each field being associated with a codepoint.

In some cases, the first indication associated with the uplink transmission configuration indicator includes an activated field in the bitmap indicating a value of a codepoint. In some cases, the second indication of the uplink power control parameter set identifier includes a first uplink power control parameter set identifier for the codepoint associated with a first antenna panel and a second uplink power control parameter set identifier for the codepoint associated with a second antenna panel.

In some cases, the bitmap is associated with a physical uplink shared channel transmission from the first antenna panel and the second antenna panel. In some cases, the control message includes a third indication of a CORESET pool identifier, where a value of the CORESET pool identifier indicates a downlink control information associated with the control message.

In some cases, the first indication associated with the uplink transmission configuration indicator includes a codepoint identifier associated with a codepoint. In some cases, the first indication associated with the uplink transmission configuration indicator includes a bitmap including multiple fields, each field being associated with a transmission configuration indicator state.

In some cases, the first indication associated with the uplink transmission configuration indicator further includes an activated field in the bitmap indicating an active transmission configuration indicator. In some cases, the second indication of the uplink power control parameter set identifier includes an uplink power control parameter set identifier associated with the active transmission configuration indicator.

In some cases, the first indication associated with the uplink transmission configuration indicator includes a bitmap including multiple fields, each field being associated with an uplink transmission configuration indicator. In some cases, the control message includes a third indication of a physical uplink control channel resource identifier. In some cases, the uplink transmission includes a physical uplink control channel transmission. In some cases, the control message includes a MAC control element.

In some cases, the uplink transmission configuration indicator includes a first uplink transmission configuration indicator state identifier for the codepoint associated with a first antenna panel and a second uplink transmission configuration indicator state identifier for the codepoint associated with a second antenna panel.

In some cases, the uplink power control parameter set identifier includes a first uplink power control parameter set identifier for the codepoint associated with the first antenna panel and a second uplink power control parameter set identifier for the codepoint associated with the second antenna panel. In some cases, the control message includes an indication of the codepoint.

In some cases, the control message includes an indication of a physical uplink control channel resource identifier. In some cases, the uplink transmission includes a physical uplink control channel transmission. In some cases, the value of the bit is zero or one. In some cases, the control message includes a MAC control element.

FIG. 13 shows a diagram of a system 1300 including a device 1305 that supports uplink power control parameter indication for multi-panel transmission in accordance with aspects of the present disclosure. The device 1305 may be an example of or include the components of device 1005, device 1105, or a UE 115 as described herein. The device 1305 may include components for bi-directional voice and data communications including components for transmitting and receiving communications, including a communications manager 1310, an I/O controller 1315, a transceiver 1320, an antenna 1325, memory 1330, and a processor 1340. These components may be in electronic communication via one or more buses (e.g., bus 1345).

The communications manager 1310 may receive, from a base station, a control message associated with an uplink transmission from one or more antenna panels, where the control message includes a first indication associated with an uplink transmission configuration indicator and a second indication of an uplink power control parameter set identifier associated with the first indication and communicate with the base station based on the first indication associated with the uplink transmission configuration indicator and the second indication of the uplink power control parameter set identifier. The communications manager 1310 may also receive, from a base station, a control message associated with an uplink transmission from one or more antenna panels, the control message including a bit, where a value of the bit indicates whether an uplink transmission configuration indicator is included in the control message or an uplink power control parameter set identifier is included in the control message and communicate with the base station based on the uplink transmission configuration indicator or the uplink power control parameter set identifier.

The I/O controller 1315 may manage input and output signals for the device 1305. The I/O controller 1315 may also manage peripherals not integrated into the device 1305. In some cases, the I/O controller 1315 may represent a physical connection or port to an external peripheral. In some cases, the I/O controller 1315 may utilize an operating system such as iOS®, ANDROID®, MS-DOS®, MS-WINDOWS®, OS/2®, UNIX®, LINUX®, or another known operating system. In other cases, the I/O controller 1315 may represent or interact with a modem, a keyboard, a mouse, a touchscreen, or a similar device. In some cases, the I/O controller 1315 may be implemented as part of a processor. In some cases, a user may interact with the device 1305 via the I/O controller 1315 or via hardware components controlled by the I/O controller 1315.

The transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas.

In some cases, the wireless device may include a single antenna 1325. However, in some cases the device may have more than one antenna 1325, which may be capable of concurrently transmitting or receiving multiple wireless transmissions.

The memory 1330 may include RAM and ROM. The memory 1330 may store computer-readable, computer-executable code 1335 including instructions that, when executed, cause the processor to perform various functions described herein. In some cases, the memory 1330 may contain, among other things, a BIOS which may control basic hardware or software operation such as the interaction with peripheral components or devices.

The processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting uplink power control parameter indication for multi-panel transmission).

The code 1335 may include instructions to implement aspects of the present disclosure, including instructions to support wireless communications. The code 1335 may be stored in a non-transitory computer-readable medium such as system memory or other type of memory. In some cases, the code 1335 may not be directly executable by the processor 1340 but may cause a computer (e.g., when compiled and executed) to perform functions described herein.

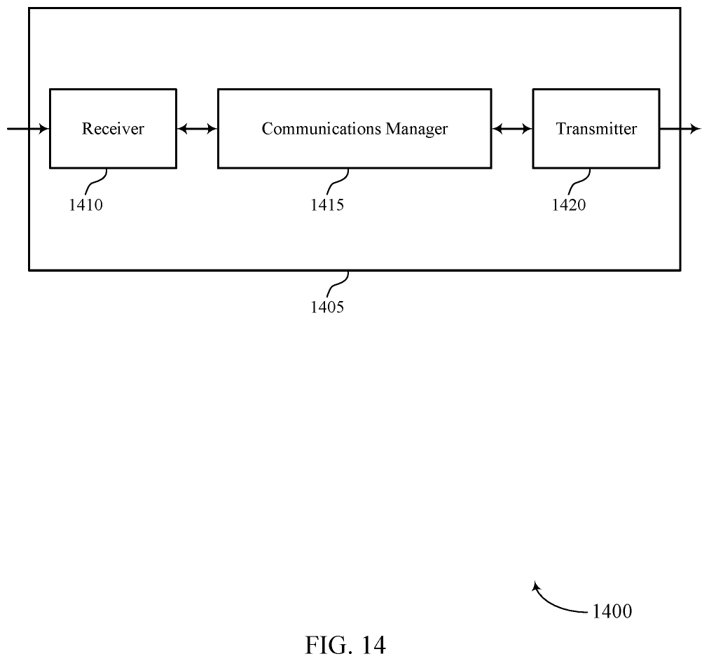

FIG. 14 shows a block diagram 1400 of a device 1405 that supports uplink power control parameter indication for multi-panel transmission in accordance with aspects of the present disclosure. The device 1405 may be an example of aspects of a base station 105 as described herein. The device 1405 may include a receiver 1410, a communications manager 1415, and a transmitter 1420. The device 1405 may also include a processor. Each of these components may be in communication with one another (e.g., via one or more buses).

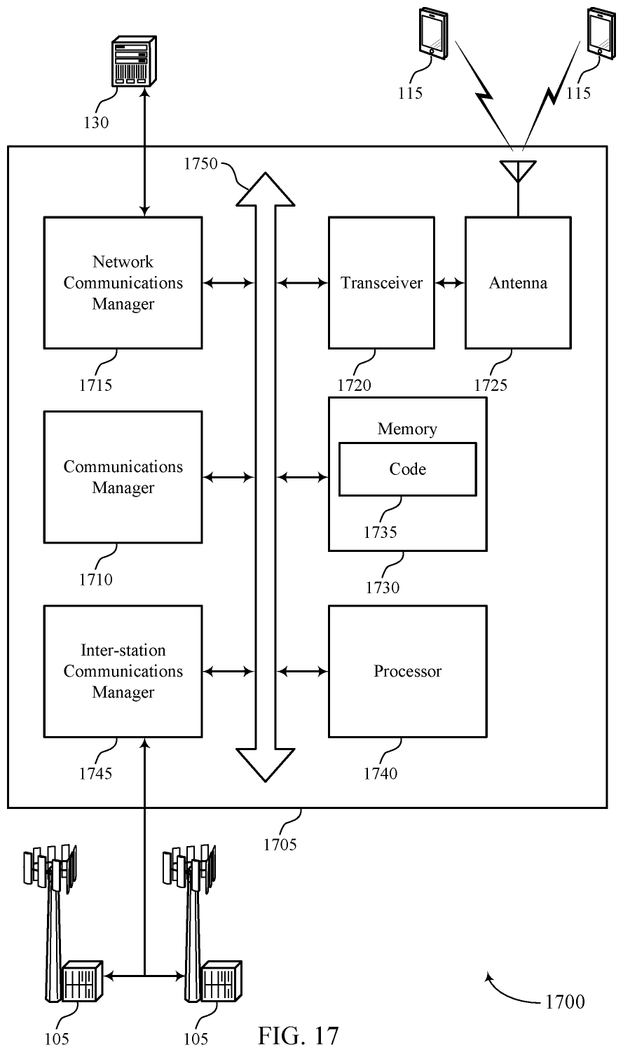

The receiver 1410 may receive information such as packets, user data, or control information associated with various information channels (e.g., control channels, data channels, and information related to uplink power control parameter indication for multi-panel transmission, etc.). Information may be passed on to other components of the device 1405. The receiver 1410 may be an example of aspects of the transceiver 1720 described with reference to FIG. 17. The receiver 1410 may utilize a single antenna or a set of antennas.

The communications manager 1415 may transmit, to a UE, a control message associated with an uplink transmission from one or more antenna panels, where the control message includes a first indication associated with an uplink transmission configuration indicator and a second indication of an uplink power control parameter set identifier associated with the first indication and communicate with the UE based on the first indication associated with the uplink transmission configuration indicator and the second indication of the uplink power control parameter set identifier. The communications manager 1415 may also transmit, to a UE, a control message associated with an uplink transmission from one or more antenna panels, the control message including a bit, where a value of the bit indicates whether an uplink transmission configuration indicator is included in the control message or an uplink power control parameter set identifier is included in the control message and communicate with the UE based on the uplink transmission configuration indicator or the uplink power control parameter set identifier. The communications manager 1415 may be an example of aspects of the communications manager 1710 described herein.

The communications manager 1415, or its sub-components, may be implemented in hardware, code (e.g., software or firmware) executed by a processor, or any combination thereof. If implemented in code executed by a processor, the functions of the communications manager 1415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1415, or its sub-components, may be physically located at various positions, including being distributed such that portions of functions are implemented at different physical locations by one or more physical components. In some examples, the communications manager 1415, or its sub-components, may be a separate and distinct component in accordance with various aspects of the present disclosure. In some examples, the communications manager 1415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 1420 may transmit signals generated by other components of the device 1405. In some examples, the transmitter 1420 may be collocated with a receiver 1410 in a transceiver module. For example, the transmitter 1420 may be an example of aspects of the transceiver 1720 described with reference to FIG. 17. The transmitter 1420 may utilize a single antenna or a set of antennas.

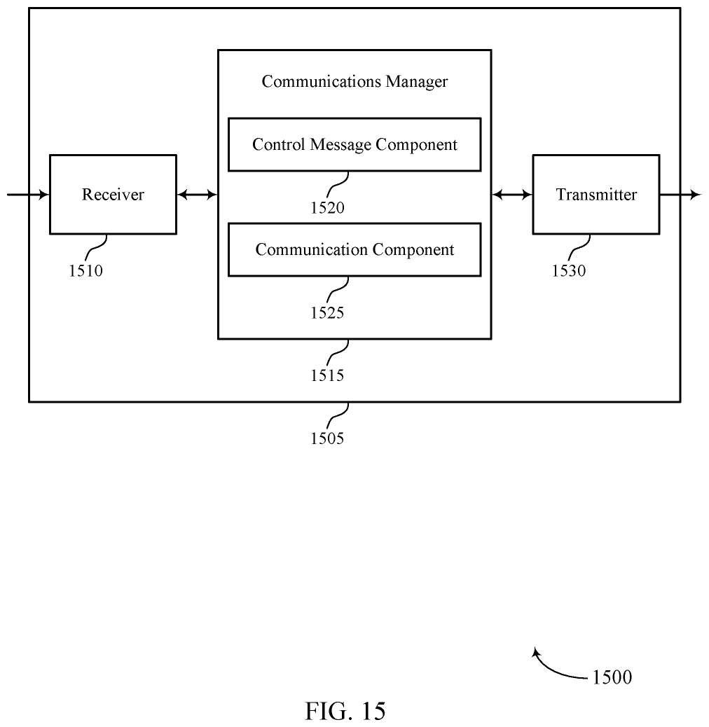

FIG. 15 shows a block diagram 1500 of a device 1505 that supports uplink power control parameter indication for multi-panel transmission in accordance with aspects of the present disclosure. The device 1505 may be an example of aspects of a device 1405, or a base station 105 as described herein. The device 1505 may include a receiver 1510, a communications manager 1515, and a transmitter 1530. The device 1505 may also include a processor. Each of these components may be in communication with one another (e.g., via one or more buses).

The receiver 1510 may receive information such as packets, user data, or control information associated with various information channels (e.g., control channels, data channels, and information related to uplink power control parameter indication for multi-panel transmission, etc.). Information may be passed on to other components of the device 1505. The receiver 1510 may be an example of aspects of the transceiver 1720 described with reference to FIG. 17. The receiver 1510 may utilize a single antenna or a set of antennas.

The communications manager 1515 may be an example of aspects of the communications manager 1415 as described herein. The communications manager 1515 may include a control message component 1520 and a communication component 1525. The communications manager 1515 may be an example of aspects of the communications manager 1710 described herein.

The control message component 1520 may transmit, to a UE, a control message associated with an uplink transmission from one or more antenna panels, where the control message includes a first indication associated with an uplink transmission configuration indicator and a second indication of an uplink power control parameter set identifier associated with the first indication. The communication component 1525 may communicate with the UE based on the first indication associated with the uplink transmission configuration indicator and the second indication of the uplink power control parameter set identifier.

The control message component 1520 may transmit, to a UE, a control message associated with an uplink transmission from one or more antenna panels, the control message including a bit, where a value of the bit indicates whether an uplink transmission configuration indicator is included in the control message or an uplink power control parameter set identifier is included in the control message. The communication component 1525 may communicate with the UE based on the uplink transmission configuration indicator or the uplink power control parameter set identifier.

The transmitter 1530 may transmit signals generated by other components of the device 1505. In some examples, the transmitter 1530 may be collocated with a receiver 1510 in a transceiver module. For example, the transmitter 1530 may be an example of aspects of the transceiver 1720 described with reference to FIG. 17. The transmitter 1530 may utilize a single antenna or a set of antennas.

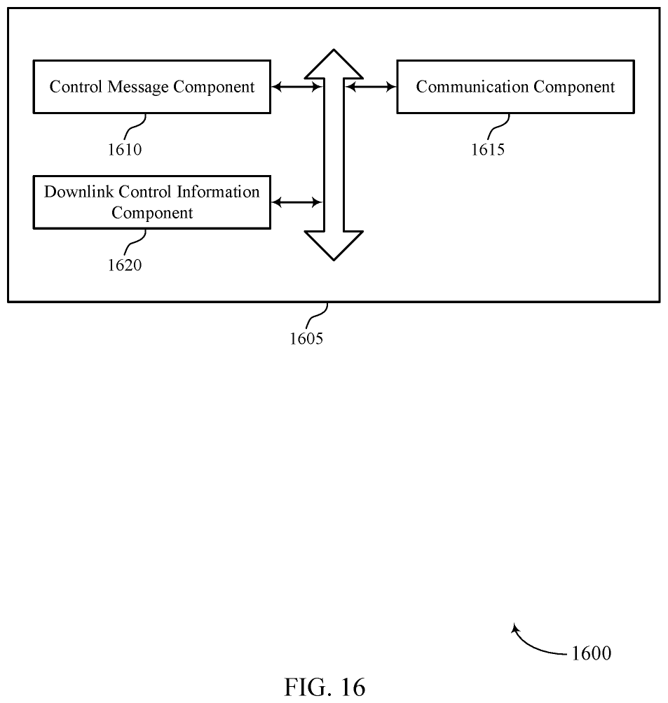

FIG. 16 shows a block diagram 1600 of a communications manager 1605 that supports uplink power control parameter indication for multi-panel transmission in accordance with aspects of the present disclosure. The communications manager 1605 may be an example of aspects of a communications manager 1415, a communications manager 1515, or a communications manager 1710 described herein. The communications manager 1605 may include a control message component 1610, a communication component 1615, and a downlink control information component 1620. Each of these modules may communicate, directly or indirectly, with one another (e.g., via one or more buses).

The control message component 1610 may transmit, to a UE, a control message associated with an uplink transmission from one or more antenna panels, where the control message includes a first indication associated with an uplink transmission configuration indicator and a second indication of an uplink power control parameter set identifier associated with the first indication. In some examples, the control message component 1610 may transmit, to a UE, a control message associated with an uplink transmission from one or more antenna panels, the control message including a bit, where a value of the bit indicates whether an uplink transmission configuration indicator is included in the control message or an uplink power control parameter set identifier is included in the control message.

The communication component 1615 may communicate with the UE based on the first indication associated with the uplink transmission configuration indicator and the second indication of the uplink power control parameter set identifier. In some examples, the communication component 1615 may communicate with the UE based on the uplink transmission configuration indicator or the uplink power control parameter set identifier.

The downlink control information component 1620 may transmit, to the UE, a downlink control information after transmitting the control message, where the downlink control information indicates a value for a codepoint. In some examples, the downlink control information component 1620 may transmit, to the UE, a downlink control information after transmitting the control message, where the downlink control information indicates a value for a codepoint.

In some cases, the downlink control information schedules a physical uplink shared channel from the first antenna panel and the second antenna panel. In some cases, the physical uplink shared channel is one or more of time division multiplexed, frequency division multiplexed, or space division multiplexed.

In some cases, the first indication associated with the uplink transmission configuration indicator includes an uplink transmission configuration indicator state identifier for the codepoint. In some cases, the first indication associated with the uplink transmission configuration indicator includes a first activated uplink transmission configuration indicator state identifier for the codepoint associated with a first antenna panel and a second activated uplink transmission configuration indicator state identifier for the codepoint associated with a second antenna panel.

In some cases, the second indication of the uplink power control parameter set identifier includes a first uplink power control parameter set identifier associated with the first activated uplink transmission configuration indicator state identifier and a second uplink power control parameter set identifier associated with the second activated uplink transmission configuration indicator state identifier.

In some cases, the control message includes a third indication of the codepoint. In some cases, the first indication associated with the uplink transmission configuration indicator includes a bitmap including multiple fields, each field being associated with a codepoint.

In some cases, the first indication associated with the uplink transmission configuration indicator includes an activated field in the bitmap indicating a value of a codepoint. In some cases, the second indication of the uplink power control parameter set identifier includes a first uplink power control parameter set identifier for the codepoint associated with a first antenna panel and a second uplink power control parameter set identifier for the codepoint associated with a second antenna panel.

In some cases, the bitmap is associated with a physical uplink shared channel transmission from the first antenna panel and the second antenna panel. In some cases, the control message includes a third indication of a CORESET pool identifier, where a value of the CORESET pool identifier indicates a downlink control information associated with the control message.

In some cases, the first indication associated with the uplink transmission configuration indicator includes a codepoint identifier associated with a codepoint. In some cases, the first indication associated with the uplink transmission configuration indicator includes a bitmap including multiple fields, each field being associated with a transmission configuration indicator state.

In some cases, the first indication associated with the uplink transmission configuration indicator further includes an activated field in the bitmap indicating an active transmission configuration indicator. In some cases, the second indication of the uplink power control parameter set identifier includes an uplink power control parameter set identifier associated with the active transmission configuration indicator.

In some cases, the first indication associated with the uplink transmission configuration indicator includes a bitmap including multiple fields, each field being associated with an uplink transmission configuration indicator. In some cases, the control message includes a third indication of a physical uplink control channel resource identifier.

In some cases, the uplink transmission includes a physical uplink control channel transmission. In some cases, the control message includes a medium access control (MAC) control element. In some cases, the uplink transmission configuration indicator is associated with the codepoint.

In some cases, the uplink transmission configuration indicator includes a first uplink transmission configuration indicator state identifier for the codepoint associated with a first antenna panel and a second uplink transmission configuration indicator state identifier for the codepoint associated with a second antenna panel. In some cases, the uplink power control parameter set identifier includes a first uplink power control parameter set identifier for the codepoint associated with the first antenna panel and a second uplink power control parameter set identifier for the codepoint associated with the second antenna panel.

In some cases, the control message includes an indication of the codepoint. In some cases, the control message includes an indication of a physical uplink control channel resource identifier. In some cases, the uplink transmission includes a physical uplink control channel transmission. In some cases, the value of the bit is zero or one.

In some cases, the control message includes a medium access control (MAC) control element. In some cases, the downlink control information schedules a physical uplink shared channel from the first antenna panel and the second antenna panel. In some cases, the physical uplink shared channel is one or more of time division multiplexed, frequency division multiplexed, or space division multiplexed.

FIG. 17 shows a diagram of a system 1700 including a device 1705 that supports uplink power control parameter indication for multi-panel transmission in accordance with aspects of the present disclosure. The device 1705 may be an example of or include the components of device 1405, device 1505, or a base station 105 as described herein. The device 1705 may include components for bi-directional voice and data communications including components for transmitting and receiving communications, including a communications manager 1710, a network communications manager 1715, a transceiver 1720, an antenna 1725, memory 1730, a processor 1740, and an inter-station communications manager 1745. These components may be in electronic communication via one or more buses (e.g., bus 1750).

The communications manager 1710 may transmit, to a UE, a control message associated with an uplink transmission from one or more antenna panels, where the control message includes a first indication associated with an uplink transmission configuration indicator and a second indication of an uplink power control parameter set identifier associated with the first indication and communicate with the UE based on the first indication associated with the uplink transmission configuration indicator and the second indication of the uplink power control parameter set identifier. The communications manager 1710 may also transmit, to a UE, a control message associated with an uplink transmission from one or more antenna panels, the control message including a bit, where a value of the bit indicates whether an uplink transmission configuration indicator is included in the control message or an uplink power control parameter set identifier is included in the control message and communicate with the UE based on the uplink transmission configuration indicator or the uplink power control parameter set identifier.

The network communications manager 1715 may manage communications with the core network (e.g., via one or more wired backhaul links). For example, the network communications manager 1715 may manage the transfer of data communications for client devices, such as one or more UEs 115.

The transceiver 1720 may communicate bi-directionally, via one or more antennas, wired, or wireless links as described above. For example, the transceiver 1720 may represent a wireless transceiver and may communicate bi-directionally with another wireless transceiver. The transceiver 1720 may also include a modem to modulate the packets and provide the modulated packets to the antennas for transmission, and to demodulate packets received from the antennas.

In some cases, the wireless device may include a single antenna 1725. However, in some cases the device may have more than one antenna 1725, which may be capable of concurrently transmitting or receiving multiple wireless transmissions.

The memory 1730 may include RAM, ROM, or a combination thereof. The memory 1730 may store computer-readable code 1735 including instructions that, when executed by a processor (e.g., the processor 1740) cause the device to perform various functions described herein. In some cases, the memory 1730 may contain, among other things, a BIOS which may control basic hardware or software operation such as the interaction with peripheral components or devices.

The processor 1740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1740 may be configured to operate a memory array using a memory controller. In some cases, a memory controller may be integrated into processor 1740. The processor 1740 may be configured to execute computer-readable instructions stored in a memory (e.g., the memory 1730) to cause the device 1705 to perform various functions (e.g., functions or tasks supporting uplink power control parameter indication for multi-panel transmission).

The inter-station communications manager 1745 may manage communications with other base station 105, and may include a controller or scheduler for controlling communications with UEs 115 in cooperation with other base stations 105. For example, the inter-station communications manager 1745 may coordinate scheduling for transmissions to UEs 115 for various interference mitigation techniques such as beamforming or joint transmission. In some examples, the inter-station communications manager 1745 may provide an X2 interface within an LTE/LTE-A wireless communication network technology to provide communication between base stations 105.

The code 1735 may include instructions to implement aspects of the present disclosure, including instructions to support wireless communications. The code 1735 may be stored in a non-transitory computer-readable medium such as system memory or other type of memory. In some cases, the code 1735 may not be directly executable by the processor 1740 but may cause a computer (e.g., when compiled and executed) to perform functions described herein.

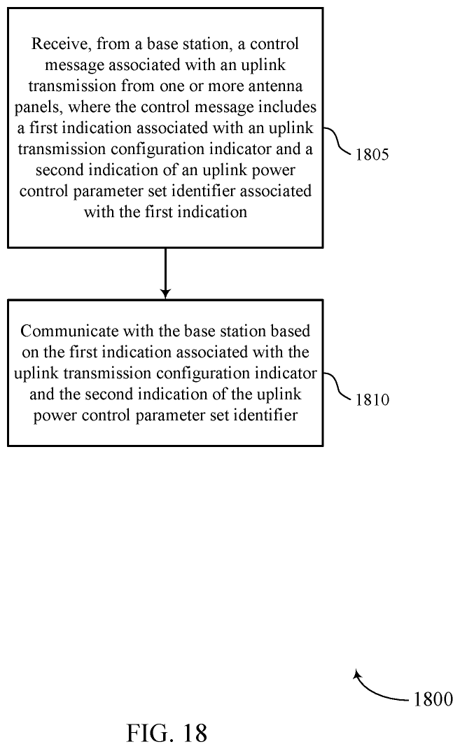

FIG. 18 shows a flowchart illustrating a method 1800 that supports uplink power control parameter indication for multi-panel transmission in accordance with aspects of the present disclosure. The operations of method 1800 may be implemented by a UE 115 or its components as described herein. For example, the operations of method 1800 may be performed by a communications manager as described with reference to FIGS. 10 through 13. In some examples, a UE may execute a set of instructions to control the functional elements of the UE to perform the functions described below. Additionally or alternatively, a UE may perform aspects of the functions described below using special-purpose hardware.

At 1805, the UE may receive, from a base station, a control message associated with an uplink transmission from one or more antenna panels, where the control message includes a first indication associated with an uplink transmission configuration indicator and a second indication of an uplink power control parameter set identifier associated with the first indication. The operations of 1805 may be performed according to the methods described herein. In some examples, aspects of the operations of 1805 may be performed by a control message component as described with reference to FIGS. 10 through 13.

At 1810, the UE may communicate with the base station based on the first indication associated with the uplink transmission configuration indicator and the second indication of the uplink power control parameter set identifier. The operations of 1810 may be performed according to the methods described herein. In some examples, aspects of the operations of 1810 may be performed by a communication component as described with reference to FIGS. 10 through 13.

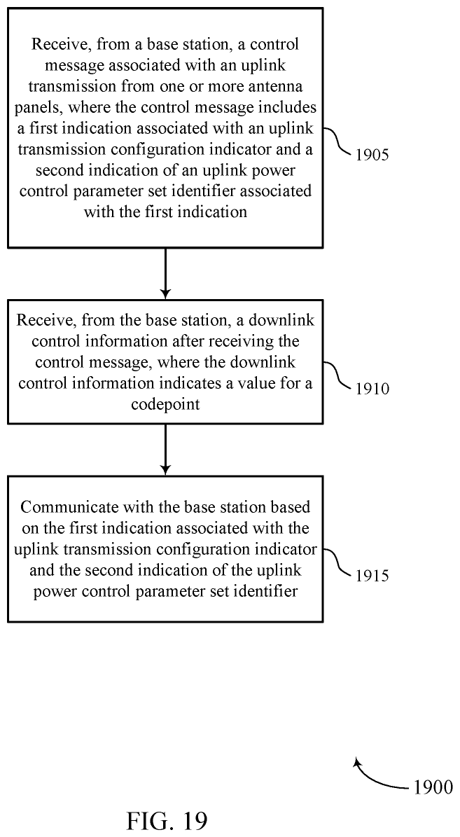

FIG. 19 shows a flowchart illustrating a method 1900 that supports uplink power control parameter indication for multi-panel transmission in accordance with aspects of the present disclosure. The operations of method 1900 may be implemented by a UE 115 or its components as described herein. For example, the operations of method 1900 may be performed by a communications manager as described with reference to FIGS. 10 through 13. In some examples, a UE may execute a set of instructions to control the functional elements of the UE to perform the functions described below. Additionally or alternatively, a UE may perform aspects of the functions described below using special-purpose hardware.

At 1905, the UE may receive, from a base station, a control message associated with an uplink transmission from one or more antenna panels, where the control message includes a first indication associated with an uplink transmission configuration indicator and a second indication of an uplink power control parameter set identifier associated with the first indication. The operations of 1905 may be performed according to the methods described herein. In some examples, aspects of the operations of 1905 may be performed by a control message component as described with reference to FIGS. 10 through 13.

At 1910, the UE may receive, from the base station, a downlink control information after receiving the control message, where the downlink control information indicates a value for a codepoint. The operations of 1910 may be performed according to the methods described herein. In some examples, aspects of the operations of 1910 may be performed by a downlink control information component as described with reference to FIGS. 10 through 13.

At 1915, the UE may communicate with the base station based on the first indication associated with the uplink transmission configuration indicator and the second indication of the uplink power control parameter set identifier. The operations of 1915 may be performed according to the methods described herein. In some examples, aspects of the operations of 1915 may be performed by a communication component as described with reference to FIGS. 10 through 13.

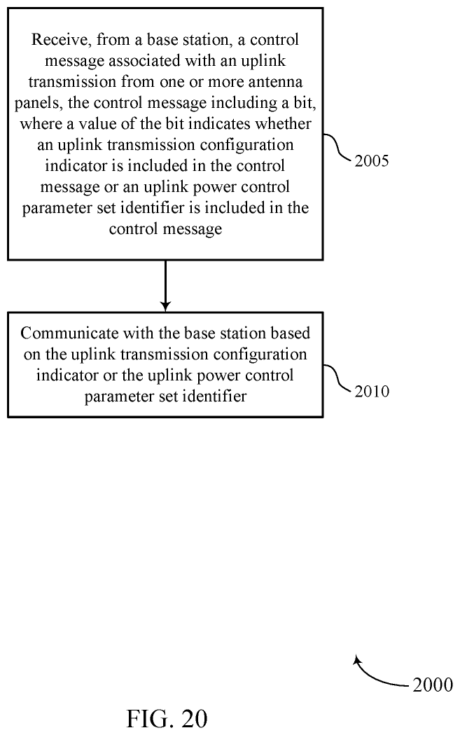

FIG. 20 shows a flowchart illustrating a method 2000 that supports uplink power control parameter indication for multi-panel transmission in accordance with aspects of the present disclosure. The operations of method 2000 may be implemented by a UE 115 or its components as described herein. For example, the operations of method 2000 may be performed by a communications manager as described with reference to FIGS. 10 through 13. In some examples, a UE may execute a set of instructions to control the functional elements of the UE to perform the functions described below. Additionally or alternatively, a UE may perform aspects of the functions described below using special-purpose hardware.

At 2005, the UE may receive, from a base station, a control message associated with an uplink transmission from one or more antenna panels, the control message including a bit, where a value of the bit indicates whether an uplink transmission configuration indicator is included in the control message or an uplink power control parameter set identifier is included in the control message. The operations of 2005 may be performed according to the methods described herein. In some examples, aspects of the operations of 2005 may be performed by a control message component as described with reference to FIGS. 10 through 13.

At 2010, the UE may communicate with the base station based on the uplink transmission configuration indicator or the uplink power control parameter set identifier. The operations of 2010 may be performed according to the methods described herein. In some examples, aspects of the operations of 2010 may be performed by a communication component as described with reference to FIGS. 10 through 13.

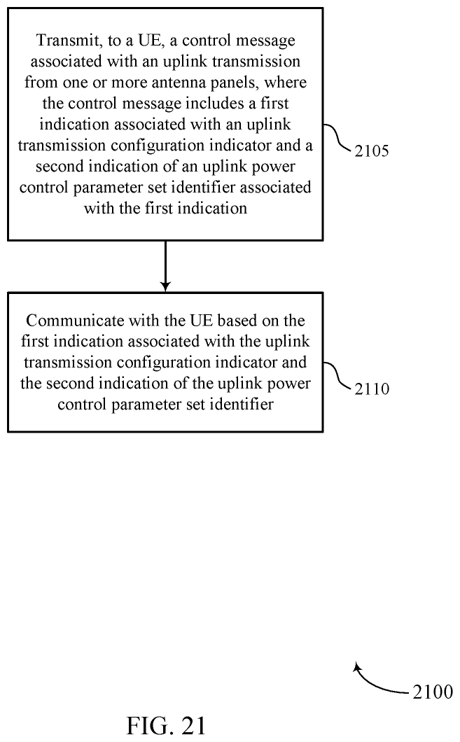

FIG. 21 shows a flowchart illustrating a method 2100 that supports uplink power control parameter indication for multi-panel transmission in accordance with aspects of the present disclosure. The operations of method 2100 may be implemented by a base station 105 or its components as described herein. For example, the operations of method 2100 may be performed by a communications manager as described with reference to FIGS. 14 through 17. In some examples, a base station may execute a set of instructions to control the functional elements of the base station to perform the functions described below. Additionally or alternatively, a base station may perform aspects of the functions described below using special-purpose hardware.

At 2105, the base station may transmit, to a UE, a control message associated with an uplink transmission from one or more antenna panels, where the control message includes a first indication associated with an uplink transmission configuration indicator and a second indication of an uplink power control parameter set identifier associated with the first indication. The operations of 2105 may be performed according to the methods described herein. In some examples, aspects of the operations of 2105 may be performed by a control message component as described with reference to FIGS. 14 through 17.

At 2110, the base station may communicate with the UE based on the first indication associated with the uplink transmission configuration indicator and the second indication of the uplink power control parameter set identifier. The operations of 2110 may be performed according to the methods described herein. In some examples, aspects of the operations of 2110 may be performed by a communication component as described with reference to FIGS. 14 through 17.

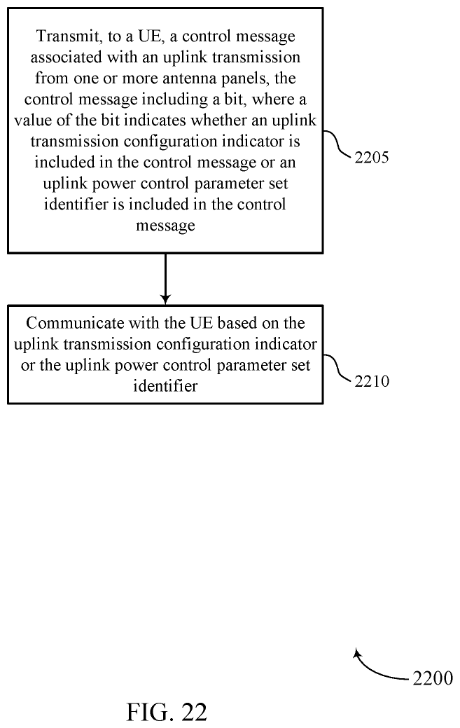

FIG. 22 shows a flowchart illustrating a method 2200 that supports uplink power control parameter indication for multi-panel transmission in accordance with aspects of the present disclosure. The operations of method 2200 may be implemented by a base station 105 or its components as described herein. For example, the operations of method 2200 may be performed by a communications manager as described with reference to FIGS. 14 through 17. In some examples, a base station may execute a set of instructions to control the functional elements of the base station to perform the functions described below. Additionally or alternatively, a base station may perform aspects of the functions described below using special-purpose hardware.

At 2205, the base station may transmit, to a UE, a control message associated with an uplink transmission from one or more antenna panels, the control message including a bit, where a value of the bit indicates whether an uplink transmission configuration indicator is included in the control message or an uplink power control parameter set identifier is included in the control message. The operations of 2205 may be performed according to the methods described herein. In some examples, aspects of the operations of 2205 may be performed by a control message component as described with reference to FIGS. 14 through 17.

At 2210, the base station may communicate with the UE based on the uplink transmission configuration indicator or the uplink power control parameter set identifier. The operations of 2210 may be performed according to the methods described herein. In some examples, aspects of the operations of 2210 may be performed by a communication component as described with reference to FIGS. 14 through 17.

It should be noted that the methods described herein describe possible implementations, and that the operations and the steps may be rearranged or otherwise modified and that other implementations are possible. Further, aspects from two or more of the methods may be combined.

The following examples are given by way of illustration. Aspects of the following examples may be combined with aspects or embodiments shown or discussed in relation to the figures or elsewhere herein.

Example 1 is method for wireless communication at a UE that includes receiving, from a base station, a control message associated with an uplink transmission from one or more antenna panels, wherein the control message comprises a first indication associated with an uplink transmission configuration indicator and a second indication of an uplink power control parameter set identifier associated with the first indication; and communicating with the base station based at least in part on the first indication associated with the uplink transmission configuration indicator and the second indication of the uplink power control parameter set identifier.

In Example 2, the method of example 1 includes receiving, from the base station, a downlink control information after receiving the control message, wherein the downlink control information indicates a value for a codepoint.

In Example 3, the method of any of examples 1-2 further includes that the first indication associated with the uplink transmission configuration indicator comprises an uplink transmission configuration indicator state identifier for the codepoint.

In Example 4, the method of any of examples 1-3 further includes that the first indication associated with the uplink transmission configuration indicator comprises a first activated uplink transmission configuration indicator state identifier for the codepoint associated with a first antenna panel and a second activated uplink transmission configuration indicator state identifier for the codepoint associated with a second antenna panel.

In Example 5, the method of any of examples 1-4 further includes that the second indication of the uplink power control parameter set identifier comprises a first uplink power control parameter set identifier associated with the first activated uplink transmission configuration indicator state identifier and a second uplink power control parameter set identifier associated with the second activated uplink transmission configuration indicator state identifier.

In Example 6, the method of any of examples 1-5 further includes that the downlink control information schedules a physical uplink shared channel from the first antenna panel and the second antenna panel.

In Example 7, the method of any of examples 1-6 further includes that the control message comprises a third indication of the codepoint.

In Example 8, the method of any of examples 1-7 further includes that the first indication associated with the uplink transmission configuration indicator comprises a bitmap including multiple fields, each field being associated with a codepoint.

In Example 9, the method of any of examples 1-8 further includes that the first indication associated with the uplink transmission configuration indicator comprises an activated field in the bitmap indicating a value of a codepoint.

In Example 10, the method of any of examples 1-9 further includes that the second indication of the uplink power control parameter set identifier comprises a first uplink power control parameter set identifier for the codepoint associated with a first antenna panel and a second uplink power control parameter set identifier for the codepoint associated with a second antenna panel.

In Example 11, the method of any of examples 1-10 further includes that the control message comprises a third indication of a CORESET pool identifier, wherein a value of the CORESET pool identifier indicates a downlink control information associated with the control message.

In Example 12, the method of any of examples 1-11 further includes that the first indication associated with the uplink transmission configuration indicator comprises a codepoint identifier associated with a codepoint.

In Example 13, the method of any of examples 1-12 further includes that the second indication of the uplink power control parameter set identifier comprises a first uplink power control parameter set identifier for the codepoint associated with a first antenna panel and a second uplink power control parameter set identifier for the codepoint associated with a second antenna panel.

In Example 14, the method of any of examples 1-13 further includes that the control message comprises a third indication of a CORESET pool identifier, wherein a value of the CORESET pool identifier indicates a downlink control information associated with the control message.

In Example 15, the method of any of examples 1-14 further includes that the first indication associated with the uplink transmission configuration indicator comprises a bitmap including multiple fields, each field being associated with a transmission configuration indicator state.

In Example 16, the method of any of examples 1-15 further includes that the first indication associated with the uplink transmission configuration indicator further comprises an activated field in the bitmap indicating an active transmission configuration indicator.

In Example 17, the method of any of examples 1-16 further includes that the second indication of the uplink power control parameter set identifier comprises an uplink power control parameter set identifier associated with the active transmission configuration indicator.

In Example 18, the method of any of examples 1-17 further includes that the control message comprises a third indication of a CORESET pool identifier, wherein a value of the CORESET pool identifier indicates a downlink control information associated with the control message.

In Example 19, the method of any of examples 1-18 further includes that the first indication associated with the uplink transmission configuration indicator comprises a bitmap including multiple fields, each field being associated with an uplink transmission configuration indicator.

In Example 20, the method of any of examples 1-19 further includes that the first indication associated with the uplink transmission configuration indicator further comprises an activated field in the bitmap indicating an active transmission configuration indicator.

In Example 21, the method of any of examples 1-20 further includes that the second indication of the uplink power control parameter set identifier comprises an uplink power control parameter set identifier associated with the active transmission configuration indicator.

In Example 22, the method of any of examples 1-21 further includes that the control message comprises a third indication of a physical uplink control channel resource identifier.

In Example 23, the method of any of examples 1-22 further includes that the uplink transmission comprises a physical uplink control channel transmission.

In Example 24, the method of any of examples 1-23 further includes that the control message comprises a MAC control element.

Example 25 is method for wireless communication at a UE that includes receiving, from a base station, a control message associated with an uplink transmission from one or more antenna panels, the control message comprising a bit, wherein a value of the bit indicates whether an uplink transmission configuration indicator is included in the control message or an uplink power control parameter set identifier is included in the control message; and communicating with the base station based at least in part on the uplink transmission configuration indicator or the uplink power control parameter set identifier.

In Example 26, the method of example 25 includes receiving, from the base station, a downlink control information after receiving the control message, wherein the downlink control information indicates a value for a codepoint.

In Example 27, the method of any of examples 25-26 further includes that the uplink transmission configuration indicator is associated with the codepoint.

In Example 28, the method of any of examples 25-27 further includes that the uplink transmission configuration indicator comprises a first uplink transmission configuration indicator state identifier for the codepoint associated with a first antenna panel and a second uplink transmission configuration indicator state identifier for the codepoint associated with a second antenna panel.

In Example 29, the method of any of examples 25-28 further includes that the uplink power control parameter set identifier comprises a first uplink power control parameter set identifier for the codepoint associated with the first antenna panel and a second uplink power control parameter set identifier for the codepoint associated with the second antenna panel.

In Example 30, the method of any of examples 25-29 further includes that the downlink control information schedules a physical uplink shared channel from the first antenna panel and the second antenna panel.

In Example 31, the method of any of examples 25-30 further includes that the control message comprises an indication of the codepoint

In Example 32, the method of any of examples 25-31 further includes that the control message comprises an indication of a physical uplink control channel resource identifier.

In Example 33, the method of any of examples 25-32 further includes that the uplink transmission comprises a physical uplink control channel transmission.

In Example 34, the method of any of examples 25-33 further includes that the value of the bit is zero or one.

In Example 35, the method of any of examples 25-34 further includes that the control message comprises a MAC control element.

Example 36 is method for wireless communication at a base station that includes transmitting, to a user equipment (UE), a control message associated with an uplink transmission from one or more antenna panels, wherein the control message comprises a first indication associated with an uplink transmission configuration indicator and a second indication of an uplink power control parameter set identifier associated with the first indication; and communicating with the UE based at least in part on the first indication associated with the uplink transmission configuration indicator and the second indication of the uplink power control parameter set identifier.

In Example 37, the method of example 36 includes transmitting, to the UE, a downlink control information after transmitting the control message, wherein the downlink control information indicates a value for a codepoint.

In Example 38, the method of any of examples 36-37 further includes that the first indication associated with the uplink transmission configuration indicator comprises an uplink transmission configuration indicator state identifier for the codepoint.

In Example 39, the method of any of examples 36-38 further includes that the first indication associated with the uplink transmission configuration indicator comprises a first activated uplink transmission configuration indicator state identifier for the codepoint associated with a first antenna panel and a second activated uplink transmission configuration indicator state identifier for the codepoint associated with a second antenna panel.

In Example 40, the method of any of examples 36-39 further includes that the second indication of the uplink power control parameter set identifier comprises a first uplink power control parameter set identifier associated with the first activated uplink transmission configuration indicator state identifier and a second uplink power control parameter set identifier associated with the second activated uplink transmission configuration indicator state identifier.

In Example 41, the method of any of examples 36-40 further includes that the downlink control information schedules a physical uplink shared channel from the first antenna panel and the second antenna panel.

In Example 42, the method of any of examples 36-41 further includes that the control message comprises a third indication of the codepoint.

In Example 43, the method of any of examples 36-42 further includes that the first indication associated with the uplink transmission configuration indicator comprises a bitmap including multiple fields, each field being associated with a codepoint.

In Example 44, the method of any of examples 36-43 further includes that the first indication associated with the uplink transmission configuration indicator comprises an activated field in the bitmap indicating a value of a codepoint.

In Example 45, the method of any of examples 36-44 further includes that the second indication of the uplink power control parameter set identifier comprises a first uplink power control parameter set identifier for the codepoint associated with a first antenna panel and a second uplink power control parameter set identifier for the codepoint associated with a second antenna panel.

In Example 46, the method of any of examples 36-45 further includes that the control message comprises a third indication of a CORESET pool identifier, wherein a value of the CORESET pool identifier indicates a downlink control information associated with the control message.

In Example 47, the method of any of examples 36-46 further includes that the first indication associated with the uplink transmission configuration indicator comprises a codepoint identifier associated with a codepoint.

In Example 48, the method of any of examples 36-47 further includes that the second indication of the uplink power control parameter set identifier comprises a first uplink power control parameter set identifier for the codepoint associated with a first antenna panel and a second uplink power control parameter set identifier for the codepoint associated with a second antenna panel.

In Example 49, the method of any of examples 36-48 further includes that the control message comprises a third indication of a CORESET pool identifier, wherein a value of the CORESET pool identifier indicates a downlink control information associated with the control message.

In Example 50, the method of any of examples 36-49 further includes that the first indication associated with the uplink transmission configuration indicator comprises a bitmap including multiple fields, each field being associated with a transmission configuration indicator state.

In Example 51, the method of any of examples 36-50 further includes that the first indication associated with the uplink transmission configuration indicator further comprises an activated field in the bitmap indicating an active transmission configuration indicator.

In Example 52, the method of any of examples 36-51 further includes that the second indication of the uplink power control parameter set identifier comprises an uplink power control parameter set identifier associated with the active transmission configuration indicator.

In Example 53, the method of any of examples 36-52 further includes that the control message comprises a third indication of a CORESET pool identifier, wherein a value of the CORESET pool identifier indicates a downlink control information associated with the control message.

In Example 54, the method of any of examples 36-53 further includes that the first indication associated with the uplink transmission configuration indicator comprises a bitmap including multiple fields, each field being associated with an uplink transmission configuration indicator.

In Example 55, the method of any of examples 36-54 further includes that the first indication associated with the uplink transmission configuration indicator further comprises an activated field in the bitmap indicating an active transmission configuration indicator.

In Example 56, the method of any of examples 36-55 further includes that the second indication of the uplink power control parameter set identifier comprises an uplink power control parameter set identifier associated with the active transmission configuration indicator.

In Example 57, the method of any of examples 36-56 further includes that the control message comprises a third indication of a physical uplink control channel resource identifier.

In Example 58, the method of any of examples 36-57 further includes that the uplink transmission comprises a physical uplink control channel transmission.

In Example 59, the method of any of examples 36-58 further includes that the control message comprises a MAC control element.

Example 60 is method for wireless communication at a base station that includes transmitting, to a user equipment (UE), a control message associated with an uplink transmission from one or more antenna panels, the control message comprising a bit, wherein a value of the bit indicates whether an uplink transmission configuration indicator is included in the control message or an uplink power control parameter set identifier is included in the control message; and communicating with the UE based at least in part on the uplink transmission configuration indicator or the uplink power control parameter set identifier.

In Example 61, the method of example 60 includes transmitting, to the UE, a downlink control information after transmitting the control message, wherein the downlink control information indicates a value for a codepoint.

In Example 62, the method of any of examples 60-61 further includes that the uplink transmission configuration indicator is associated with the codepoint.

In Example 63, the method of any of examples 60-62 further includes that the uplink transmission configuration indicator comprises a first uplink transmission configuration indicator state identifier for the codepoint associated with a first antenna panel and a second uplink transmission configuration indicator state identifier for the codepoint associated with a second antenna panel,

In Example 64, the method of any of examples 60-63 further includes that the uplink power control parameter set identifier comprises a first uplink power control parameter set identifier for the codepoint associated with the first antenna panel and a second uplink power control parameter set identifier for the codepoint associated with the second antenna panel.

In Example 65, the method of any of examples 60-64 further includes that the downlink control information schedules a physical uplink shared channel from the first antenna panel and the second antenna panel.

In Example 66, the method of any of examples 60-65 further includes that the control message comprises an indication of the codepoint.

In Example 67, the method of any of examples 60-66 further includes that the control message comprises an indication of a physical uplink control channel resource identifier.

In Example 68, the method of any of examples 60-67 further includes that the uplink transmission comprises a physical uplink control channel transmission.

In Example 69, the method of any of examples 60-68 further includes that the value of the bit is zero or one.

In Example 70, the method of any of examples 60-69 further includes that the control message comprises a MAC control element.

Example 71 is a system or apparatus including means for implementing a method or realizing an apparatus as in any of examples 1-24.

Example 72 is a system or apparatus including means for implementing a method or realizing an apparatus as in any of examples 25-35.

Example 73 is a system or apparatus including means for implementing a method or realizing an apparatus as in any of examples 36-59

Example 74 is a system or apparatus including means for implementing a method or realizing an apparatus as in any of examples 60-70.

Example 75 is a non-transitory computer-readable medium storing instructions executable by one or more processors to cause the one or more processors to implement a method as in any of examples 1-24.

Example 76 is a non-transitory computer-readable medium storing instructions executable by one or more processors to cause the one or more processors to implement a method as in any of examples 25-35.

Example 77 is a non-transitory computer-readable medium storing instructions executable by one or more processors to cause the one or more processors to implement a method as in any of examples 36-59.

Example 78 is a non-transitory computer-readable medium storing instructions executable by one or more processors to cause the one or more processors to implement a method as in any of examples 60-70.

Example 79 is a system including one or more processors and memory in electronic communication with the one or more processors storing instructions executable by the one or more processors to cause the system or apparatus to implement a method as in any of examples 1-24.

Example 80 is a system including one or more processors and memory in electronic communication with the one or more processors storing instructions executable by the one or more processors to cause the system or apparatus to implement a method as in any of examples 25-35.

Example 81 is a system including one or more processors and memory in electronic communication with the one or more processors storing instructions executable by the one or more processors to cause the system or apparatus to implement a method as in any of examples 36-59.

Example 82 is a system including one or more processors and memory in electronic communication with the one or more processors storing instructions executable by the one or more processors to cause the system or apparatus to implement a method as in any of examples 60-70.

Aspects of these examples may be combined with aspects or embodiments disclosed in other implementations.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
receiving, from a network entity, a control message associated with an uplink transmission from one or more antenna panels, wherein the control message comprises a first indication associated with an uplink transmission configuration indicator and a second indication of an uplink power control parameter set identifier associated with the first indication; and
communicating with the network entity based at least in part on the first indication associated with the uplink transmission configuration indicator and the second indication of the uplink power control parameter set identifier.

2. The method of claim 1, further comprising:
receiving, from the network entity, a downlink control information after receiving the control message, wherein the downlink control information indicates a value for a codepoint.

3. The method of claim 2, wherein the first indication associated with the uplink transmission configuration indicator comprises an uplink transmission configuration indicator state identifier for the codepoint.

4. The method of claim 2, wherein the first indication associated with the uplink transmission configuration indicator comprises a first activated uplink transmission configuration indicator state identifier for the codepoint associated with a first antenna panel and a second activated uplink transmission configuration indicator state identifier for the codepoint associated with a second antenna panel.

5. The method of claim 4, wherein the second indication of the uplink power control parameter set identifier comprises a first uplink power control parameter set identifier associated with the first activated uplink transmission configuration indicator state identifier and a second uplink power control parameter set identifier associated with the second activated uplink transmission configuration indicator state identifier.

6. The method of claim 4, wherein the downlink control information schedules a physical uplink shared channel from the first antenna panel and the second antenna panel.

7. The method of claim 2, wherein the control message comprises a third indication of the codepoint.

8. The method of claim 1, wherein the first indication associated with the uplink transmission configuration indicator comprises a bitmap including multiple fields, each field being associated with a codepoint.

9. The method of claim 8, wherein the first indication associated with the uplink transmission configuration indicator comprises an activated field in the bitmap indicating a value of a codepoint.

10. The method of claim 9, wherein the second indication of the uplink power control parameter set identifier comprises a first uplink power control parameter set identifier for the codepoint associated with a first antenna panel and a second uplink power control parameter set identifier for the codepoint associated with a second antenna panel.

11. The method of claim 8, wherein the control message comprises a third indication of a control resource set (CORESET) pool identifier, wherein a value of the CORESET pool identifier indicates a downlink control information associated with the control message.

12. The method of claim 1, wherein the first indication associated with the uplink transmission configuration indicator comprises a codepoint identifier associated with a codepoint.

13. The method of claim 12, wherein the second indication of the uplink power control parameter set identifier comprises a first uplink power control parameter set identifier for the codepoint associated with a first antenna panel and a second uplink power control parameter set identifier for the codepoint associated with a second antenna panel.

14. The method of claim 12, wherein the control message comprises a third indication of a control resource set (CORESET) pool identifier, wherein a value of the CORESET pool identifier indicates a downlink control information associated with the control message.

15. The method of claim 1, wherein the first indication associated with the uplink transmission configuration indicator comprises a bitmap including multiple fields, each field being associated with a transmission configuration indicator state.

16. The method of claim 15, wherein the first indication associated with the uplink transmission configuration indicator further comprises an activated field in the bitmap indicating an active transmission configuration indicator.

17. The method of claim 16, wherein the second indication of the uplink power control parameter set identifier comprises an uplink power control parameter set identifier associated with the active transmission configuration indicator.

18. The method of claim 15, wherein the control message comprises a third indication of a control resource set (CORESET) pool identifier, wherein a value of the CORESET pool identifier indicates a downlink control information associated with the control message.

19. The method of claim 1, wherein the first indication associated with the uplink transmission configuration indicator comprises a bitmap including multiple fields, each field being associated with an uplink transmission configuration indicator.

20. The method of claim 19, wherein the first indication associated with the uplink transmission configuration indicator further comprises an activated field in the bitmap indicating an active transmission configuration indicator.

21. The method of claim 19, wherein the second indication of the uplink power control parameter set identifier comprises an uplink power control parameter set identifier associated with the active transmission configuration indicator.

22. The method of claim 19, wherein the control message comprises a third indication of a physical uplink control channel resource identifier.

23-24. (canceled)

25. A method for wireless communication at a user equipment (UE), comprising:
receiving, from a network entity, a control message associated with an uplink transmission from one or more antenna panels, the control message comprising a bit, wherein a value of the bit indicates whether an uplink transmission configuration indicator is included in the control message or an uplink power control parameter set identifier is included in the control message; and
communicating with the network entity based at least in part on the uplink transmission configuration indicator or the uplink power control parameter set identifier.

26. The method of claim 25, further comprising:
receiving, from the network entity, a downlink control information after receiving the control message, wherein the downlink control information indicates a value for a codepoint.

27. The method of claim 26, wherein the uplink transmission configuration indicator is associated with the codepoint.

28. The method of claim 26, wherein the uplink transmission configuration indicator comprises a first uplink transmission configuration indicator state identifier for the codepoint associated with a first antenna panel and a second uplink transmission configuration indicator state identifier for the codepoint associated with a second antenna panel.

29. The method of claim 28, wherein the uplink power control parameter set identifier comprises a first uplink power control parameter set identifier for the codepoint associated with the first antenna panel and a second uplink power control parameter set identifier for the codepoint associated with the second antenna panel.

30-35. (canceled)

36. A method for wireless communication at a network entity, comprising:
transmitting, to a user equipment (UE), a control message associated with an uplink transmission from one or more antenna panels, wherein the control message comprises a first indication associated with an uplink transmission configuration indicator and a second indication of an uplink power control parameter set identifier associated with the first indication; and
communicating with the UE based at least in part on the first indication associated with the uplink transmission configuration indicator and the second indication of the uplink power control parameter set identifier.

37. The method of claim 36, further comprising:
transmitting, to the UE, a downlink control information after transmitting the control message, wherein the downlink control information indicates a value for a codepoint.

38-59. (canceled)

60. A method for wireless communication at a network entity, comprising:
transmitting, to a user equipment (UE), a control message associated with an uplink transmission from one or more antenna panels, the control message comprising a bit, wherein a value of the bit indicates whether an uplink transmission configuration indicator is included in the control message or an uplink power control parameter set identifier is included in the control message; and
communicating with the UE based at least in part on the uplink transmission configuration indicator or the uplink power control parameter set identifier.

61-82. (canceled)
